(19) United States
(12) Patent Application Publication
(10) Pub. No.: US 2025/0368056 A1
(43) Pub. Date: Dec. 4, 2025

(54) BATTERY AND BATTERY SWITCHING SYSTEM FOR ELECTRIC VEHICLES

(71) Applicant: EV Eco Rental SRL, Bucharest (RO)

(72) Inventors: Eduard Anghel, Bucharest (RO); Cosmin Valeanu, Bucharest (RO); Cosmin Pruna, Bucharest (RO); Dorinel Duma, Bucharest (RO); Alexandru Slavu, Bucharest (RO); Alexandru Vasiliu, Bucharest (RO); George Stan, Bucharest (RO); Alex Craia, Bucharest (RO)

(21) Appl. No.: 18/929,197

(22) Filed: Oct. 28, 2024

(30) Foreign Application Priority Data
Jun. 4, 2024 (RO) A/00296/2024

(51) Int. Cl. B60L 50/64; B60L 53/80; B60L 58/12; B60L 58/18; B60L 58/25

(52) U.S. Cl. CPC B60L 50/64; B60L 53/80; B60L 58/12; B60L 58/18; B60L 58/25; B60L 2250/16

(57) ABSTRACT

This disclosure provides an improved universal interchangeable battery for electric vehicles forming part of a battery swapping ecosystem that includes electric vehicles, swappable batteries, a charging/swap station, a battery adaptor for reliable charging and communication, and a mobile application for managing battery swapping within a fleet and a network of charging stations, enabling efficient and user-friendly battery exchanges.

### CROSS-REFERENCE TO RELATED APPLICATIONS

This patent application claims priority to Romanian Application No. A/00296/2024, filed on Jun. 4, 2024, which is incorporated by reference herein in its entirety.

### TECHNICAL FIELD

This disclosure relates generally to the field of electric vehicles and more specifically, in certain embodiments, to a swappable battery and associated battery switching and battery controls systems.

### BACKGROUND

Electric vehicles are a growing segment of the transportation industry. For instance, in urban environments, electric vehicles can be used as a more sustainable alternative to gas-powered vehicles that is also more carbon and noise neutral. However, there exists a need for improved technologies to facilitate a more widespread adoption of electric vehicles.

### SUMMARY

This disclosure relates to the field of vehicular power systems and electronics, specifically focusing on battery design, battery management, and power distribution in electric vehicles, and a multi-battery charging station. This disclosure also provides improved control systems and circuitry for seamless power switchover and fault tolerance.

The disclosed technology addresses several technical challenges related to electric vehicles, such as electronic scooters (e-scooters), bicycles, scooters, cars, cargo vans, golf carts, boats, drones, aircraft, etc., and their operation. These challenges include, for example, the need for uninterrupted power supply during vehicle operation, efficient management of battery sources, mitigation of voltage spikes and system faults, and the provision of redundancy for enhanced reliability. Prior technologies may have struggled with seamless battery switchover, leading to disruptions in vehicle operation, potential damage from electrical surges, and decreased reliability. This disclosure seeks to overcome these drawbacks by offering a comprehensive solution for smooth power management and fault tolerance in electric vehicles, thereby advancing the viability and adoption of sustainable transportation technologies.

This disclosure provides a universal interchangeable battery that can be used in electric vehicles and easily swapped out by vehicle operators. The technology described in this disclosure may form part of a battery swapping ecosystem disclosed herein that includes a set of electric vehicles, interchangeable/swappable universal batteries for powering the electric vehicles, a charging and swap station for charging the batteries, and a battery adaptor installed in the electric vehicles that quickly and reliably charges these batteries and integrates with the batteries, providing reliable communication with the batteries and a user-friendly battery-swapping experience, such that electric vehicle operators can easily and efficiently swap depleted batteries with charged ones, thus facilitating use of the swappable universal battery. This disclosure further provides a mobile application that manages various aspects of the ecosystem, such as battery swapping between a fleet of electric vehicles and a network of charging/swap stations that store and charge batteries that can be used to power the vehicles.

In an aspect of the present disclosure, a swappable universal battery for powering an electric vehicle is sized and shaped to be moved between the electric vehicle and a charger. The swappable universal battery includes: a housing storing at least one battery cell, the housing configured to be removably secured in the electric vehicle and in a charging port of the charger; a first plug located on a bottom surface of the housing, the first plug configured to allow charging of the at least one battery cell when the swappable universal battery is in the charger and to allow powering of the electric vehicle by the at least one battery cells when the swappable universal battery is in the electric vehicle; and at least one second plug located on a top surface of the housing, the at least one second plug configured to connect to the electric vehicle and power the electric vehicle in combination with another swappable universal battery.

In some embodiments, the housing includes an alignment slot configured to: align the housing within the electric vehicle when the swappable universal battery is used to power the electric vehicle, and align the housing with the charging port of the charger when the swappable universal battery is charged.

In some embodiments, the housing includes a locking mechanism configured to: secure the housing within the electric vehicle when the swappable universal battery is used to power the electric vehicle, and secure the housing within the charging port of the charger when the swappable universal battery is charged.

In some embodiments, the swappable universal battery further includes a handle attached to the housing, the handle facilitating movement of the swappable universal battery between the electric vehicle and the charger by an operator of the electric vehicle.

In some embodiments, the swappable universal battery further includes a display coupled to the housing, the display configured to show properties of the battery, the properties including at least one of a battery state of charge, a battery voltage, a battery current, a battery temperature, a wireless connection status, and an error status. In some embodiments, the battery can be used to power a second electric vehicle of a different type than the electric vehicle.

In some embodiments, the swappable universal battery further includes isolation circuitry configured, when a relay of the isolation circuitry is opened, to electronically isolate the swappable universal battery from power systems of the electric vehicle.

In some embodiments, the swappable universal battery further includes a controller configured to, when the battery is providing power to the electric vehicle: detect a battery fault or low state of charge of the battery; isolate the battery from the electric vehicle; and allow a backup battery to power the electric vehicle.

In another aspect of the present disclosure, a process is provided for managing a pair of swappable universal batteries, the pair including a first battery being used to power an electric vehicle and a second battery acting as a backup battery. The process includes: detecting a status of the first battery; determining that switching to the second battery is needed based on the detected status; and, in response to determining that switching to the second battery is needed, synchronously causing the second battery to begin powering the electric vehicle and electronically isolating the first battery from the electric vehicle.

In some embodiments, the process further includes determining that switching to the second battery is needed by determining that a temperature of the first battery is greater than a threshold value. In some embodiments, the process further includes determining that switching to the second battery is needed by detecting a fault of the first battery. In some embodiments, the process further includes determining that switching to the second battery is needed by determining that a state of charge of the first battery is less than a threshold value.

In some embodiments, synchronously causing the second battery to begin powering the electric vehicle and electronically isolating the first battery from the electric vehicle includes: generating a synchronization signal shared by the first battery and the second battery; at a predefined timepoint indicated by the synchronization signal: opening a relay of the first battery connecting the first battery to power systems of the electric vehicle, thereby isolating the first battery from the electric vehicle; and closing a relay of the second battery connecting the second battery to the power systems of the electric vehicle, thereby allowing the second battery to power the electric vehicle. The synchronization signal may be generated by a timing circuit in communication with the first battery and the second battery.

In another aspect of the present disclosure, a controller is provided for managing a pair of swappable universal batteries, the pair including a first battery being used to power an electric vehicle and a second battery acting as a backup battery. The controller includes a processor configured to: detect a status of the first battery; determine that switching to the second battery is needed based on the detected status; and, in response to determining that switching to the second battery is needed, synchronously cause the second battery to begin powering the electric vehicle and electronically isolate the first battery from the electric vehicle.

In some embodiments, the processor is configured to determine that switching to the second battery is needed by determining that a temperature of the first battery is greater than a threshold value. In some embodiments, the processor is configured to determine that switching to the second battery is needed by detecting a fault of the first battery. In some embodiments, the processor is configured to determine that switching to the second battery is needed by determining that a state of charge of the first battery is less than a threshold value.

In some embodiments, the processor is configured to synchronously cause the second battery to begin powering the electric vehicle and electronically isolate the first battery from the electric vehicle by: generating a synchronization signal shared by the first battery and the second battery; at a predefined timepoint indicated by the synchronization signal: opening a relay of the first battery connecting the first battery to power systems of the electric vehicle, thereby isolating the first battery from the electric vehicle; and closing a relay of the second battery connecting the second battery to the power systems of the electric vehicle, thereby allowing the second battery to power the electric vehicle. The synchronization signal may be generated by a timing circuit in communication with the first battery and the second battery

In another aspect of the present disclosure, a battery swapping station includes: one or more controllers with control circuitry storing control logic for controlling operations of the battery swapping station; a frame that forms a plurality of charging compartments, each charging compartment sized and shaped to receive a swappable universal battery, each charging compartment comprising: a door; a door lock controlled by the one or more controllers; and a charging port positioned behind the door and coupled to a power source, the charging port configured to connect to a charging plug of the swappable universal battery when the swappable universal battery is placed in the charging compartment.

In some embodiments, each charging compartment further comprising an alignment guide configured to align with an alignment slot of the swappable universal battery when the swappable universal battery is placed in the charging compartment.

In some embodiments, the one or more controllers are configured to: receive a temperature of the swappable universal battery in the charging compartment; and adjust charging parameters of the swappable universal battery based on the received temperature. The one or more controllers may be configured to slow or temporarily pause charging if the temperature is greater than a threshold value. The one or more controllers may be configured to: determine that the temperature of the swappable universal battery is greater than a threshold value; and in response to determining that the temperature of the swappable universal battery is greater than the threshold value, activate cooling of the swappable universal battery.

In some embodiments, the battery swapping station further includes a backup power supply configured to provide power to the one or more controllers when a main power supply is not available. The backup power supply may be a swappable universal battery within a charging compartment of the battery swapping station. The battery swapping station may further include a solar panel configured to charge the backup power supply. The battery swapping station may include wheels and be movable, wherein the backup power supply powers the one or more controllers when the main power supply is disconnected to facilitate movement of the battery swapping station.

In some embodiments, the one or more controllers are configured to: receive a command to allow access to a first battery in a first charging compartment with a first door and a first door lock; after receiving the command, unlock the first door lock; confirm that the first battery has been removed from the first charging compartment; after confirming that the first battery has been removed from the first charging compartment, confirm that a discharged battery has been placed in the first charging compartment and that the first charging compartment has been closed; and after confirming that the discharged battery has been placed in the first charging compartment and that the first charging compartment has been closed, lock the first door. The one or more controllers may be configured to: confirm that the discharged battery placed in the first charging compartment can be recharged; begin charging the discharged battery placed in the first charging compartment; and cause display of a notification indicating that a battery swap is complete.

In some embodiments, the charging port includes a multi-prong charging connector; and the swappable universal battery includes: a housing storing one or more battery cells and configured to be removably secured in the charging compartment; and a plug located on a bottom surface of the housing, the plug configured to connect the one or more battery cells to the multi-prong charging connector.

In some embodiments, the one or more controllers include: a station controller configured to manage display and communication of station properties; and for each charging compartment, a corresponding compartment controller coupled to the station controller and configured to control charging functions of the charging compartment.

In another aspect of the present disclosure, a process is provided for operating a battery swapping station having a plurality of charging compartments, each charging compartment sized and shaped to receive a swappable universal battery, wherein each charging compartment including a door, a door lock, and a charging port positioned behind the door and coupled to a power source, the charging port configured to connect to a charging plug of the swappable universal battery when the swappable universal battery is placed in the charging compartment. The process includes: receiving a command to allow access to a first battery in a first charging compartment with a first door and a first door lock; after receiving the command, unlocking the first door lock; confirming that the first battery has been removed from the first charging compartment; after confirming that the first battery has been removed from the first charging compartment, confirming that a discharged battery has been placed in the first charging compartment and that the first charging compartment has been closed; and after confirming that the discharged battery has been placed in the first charging compartment and that the first charging compartment has been closed, locking the first door.

In some embodiments, the process further includes: confirming that the discharged battery placed in the first charging compartment can be recharged; beginning to charge the discharged battery placed in the first charging compartment; and causing display of a notification indicating that the battery swap is complete.

In some embodiments, the process further includes: receiving a temperature of the swappable universal battery in the compartment; and adjusting charging parameters of the swappable universal battery based on the received temperature. In some embodiments, the process further includes: determining that the temperature of the swappable universal battery is greater than a threshold value; and in response to determining that the temperature of the swappable universal battery is greater than the threshold value, perform one or both of: slowing or temporarily pausing charging of the swappable universal battery; and cooling the swappable universal battery.

In another aspect of the present disclosure, a control system is provided for a battery swapping station having a plurality of charging compartments, each charging compartment sized and shaped to receive a swappable universal battery, wherein each charging compartment including a door, a door lock, and a charging port positioned behind the door and coupled to a power source, the charging port configured to connect to a charging plug of the swappable universal battery when the swappable universal battery is placed in the charging compartment. The control system includes one or more controllers configured to: receive a command to allow access to a first battery in a first charging compartment with a first door and a first door lock; after receiving the command, unlock the first door lock; confirm that the first battery has been removed from the first charging compartment; after confirming that the first battery has been removed from the first charging compartment, confirm that a discharged battery has been placed in the first charging compartment and that the first charging compartment has been closed; and after confirming that the discharged battery has been placed in the first charging compartment and that the first charging compartment has been closed, lock the first door.

In some embodiments, the one or more controllers are configured to: confirm that the discharged battery placed in the first charging compartment can be recharged; begin charging the discharged battery placed in the first charging compartment; and cause display of a notification indicating that the battery swap is complete.

In some embodiments, the one or more controllers are configured to: receive a temperature of the swappable universal battery in the compartment; and adjust charging parameters of the swappable universal battery based on the received temperature.

In another aspect of the present disclosure, a battery swap adapter includes: a housing having a plurality of compartments, each compartment configured to accommodate a battery; and a battery switching controller communicatively coupled to a motor controller of a vehicle in which the battery swap adapter is installed, the battery switching controller configured to: provide power from a first portion of a set of batteries held in compartments of the housing to the motor controller of the vehicle; after providing power from the first portion of the set of batteries to the motor controller for a predetermined period of time, determine whether a charge state of the first portion of the set of batteries is below a threshold level; and when the charge state of the first portion of the set of batters is determined to be below the threshold level, then: stop providing power from the first portion of the set of batteries to the motor controller; and start providing power from a second portion of the set of batteries to the motor controller.

In some embodiments, the battery switching controller is further configured to: provide power to the motor controller from the set of batteries in a redundant power configuration during a first period of time, wherein, in the redundant power configuration, the first portion of the set of batteries provides power to the motor controller while the second portion of the batteries is reserved for backup power; and provide power to the motor controller from the set of batteries in a high-power configuration during a second period of time, wherein, in the high-power configuration, both the first portion and the second portion of the set of batteries provide power to the motor controller.

In some embodiments, the battery switching controller is further configured to: receive an instruction, provided via a user application, to switch a power configuration of the battery swap adapter to a selected power configuration; and provide power to the motor controller from the set of batteries in the selected power configuration. In some embodiments, the battery switching controller is further configured, prior to providing power to the motor controller from the set of batteries in the selected power configuration, confirm the selected power configuration is allowed for a user of the vehicle.

In some embodiments, the battery switching controller is further configured to: determine a predefined power configuration for a user of the vehicle; and provide power to the motor controller from the set of batteries in the predefined power configuration for the user.

In some embodiments, the battery switching controller is further configured to: determine whether a fault has occurred in at least one battery of the first portion of the set of batteries; and

when the fault is determined to have occurred, then: stop providing power from the first portion of the set of batteries to the motor controller; and start providing power from a second portion of the set of batteries to the motor controller.

In some embodiments, the battery switching controller is further configured to: determine whether a temperature of at least one battery of the first portion of the set of batteries is greater than a threshold temperature; and when the temperature is determined to be greater than the threshold temperature, then: stop providing power from the first portion of the set of batteries to the motor controller; and start providing power from a second portion of the set of batteries to the motor controller.

In some embodiments, each compartment of the plurality of compartments includes an alignment guide configured to align with an alignment slot of the battery when the battery is placed in the compartment. In some embodiments, the battery switching controller is in communication with the motor controller via RS485 communication.

In another aspect of the present disclosure, a method is provided for powering a vehicle using a battery swap adapter with a housing having a plurality of compartments, each compartment configured to accommodate a battery. The method includes, by a battery switching controller communicatively coupled to a motor controller of the vehicle in which the battery swap adapter is installed: providing power from a first portion of a set of batteries held in compartments of the housing to the motor controller; after providing power from the first portion of the set of batteries to the motor controller for a predetermined period of time, determining whether a charge state of the first portion of the set of batteries is below a threshold level; and when the charge state of the first portion of the set of batters is determined to be below the threshold level, then: stopping providing power from the first portion of the set of batteries to the motor controller; and starting providing power from a second portion of the set of batteries to the motor controller.

In some embodiments, the method further includes: providing power to the motor controller from the set of batteries in a redundant power configuration during a first period of time, wherein, in the redundant power configuration, the first portion of the set of batteries provides power to the motor controller while the second portion of the batteries is reserved for backup power; and providing power to the motor controller from the set of batteries in a high-power configuration during a second period of time, wherein, in the high-power configuration, both the first portion and the second portion of the set of batteries provide power to the motor controller.

In some embodiments, the method further includes: receiving an instruction, provided via a user application, to switch a power configuration of the battery swap adapter to a selected power configuration; and providing power to the motor controller from the set of batteries in the selected power configuration. In some embodiments, the method further includes, prior to providing power to the motor controller from the set of batteries in the selected power configuration, confirming the selected power configuration is allowed for a user of the vehicle.

In some embodiments, the method further includes: determining a predefined power configuration for a user of the vehicle; and providing power to the motor controller from the set of batteries in the predefined power configuration for the user.

In some embodiments, the method further includes: determining whether a fault has occurred in at least one battery of the first portion of the set of batteries; and when the fault is determined to have occurred, then: stopping providing power from the first portion of the set of batteries to the motor controller; and starting providing power from a second portion of the set of batteries to the motor controller.

In some embodiments, the method further includes: determining whether a temperature of at least one battery of the first portion of the set of batteries is greater than a threshold temperature; and when the temperature is determined to be greater than the threshold temperature, then: stopping providing power from the first portion of the set of batteries to the motor controller; and starting providing power from a second portion of the set of batteries to the motor controller.

In another aspect of the present disclosure, a battery switching controller is communicatively coupled to a motor controller of a vehicle in which a battery swap adapter is installed. The battery switching controller includes a processor configured to: provide power from a first portion of a set of batteries held in compartments of a housing of the battery swap adapter to the motor controller of the vehicle; after providing power from the first portion of the set of batteries to the motor controller for a predetermined period of time, determine whether a charge state of the first portion of the set of batteries is below a threshold level; and when the charge state of the first portion of the set of batters is determined to be below the threshold level, then: stop providing power from the first portion of the set of batteries to the motor controller; and start providing power from a second portion of the set of batteries to the motor controller.

In some embodiments, the processor is further configured to: provide power to the motor controller from the set of batteries in a redundant power configuration during a first period of time, wherein, in the redundant power configuration, the first portion of the set of batteries provides power to the motor controller while the second portion of the batteries is reserved for backup power; and provide power to the motor controller from the set of batteries in a high-power configuration during a second period of time, wherein, in the high-power configuration, both the first portion and the second portion of the set of batteries provide power to the motor controller.

In some embodiments, the processor is further configured to: receive an instruction, provided via a user application, to switch a power configuration of the battery swap adapter to a selected power configuration; and provide power to the motor controller from the set of batteries in the selected power configuration.

In another aspect of the present disclosure, a battery swapping system includes a server in communication with a controller of a battery swap station storing batteries and a user device, wherein the server is configured to: receive a request provided at the user device to perform a battery swap at the battery swap station; determine a selected battery to provide in the requested battery swap based on one or both of a charge state of the batteries stored in the battery swap station and a number of charge cycles previously performed on the batteries stored at the battery swap station; and provide a command to the controller of the battery swap station instructing the battery swap station to allow a door to open of a compartment storing the selected battery.

In some embodiments, the server is further configured to confirm that a requester associated with the request is within a threshold distance of the battery swap station before providing the command. In some embodiments, the server is further configured to determine that the battery swap station can complete the requested battery swap before providing the command. In some embodiments, the server is further configured to determine that a requester associated with the request is allowed to complete the requested battery swap before providing the command. In some embodiments, the server is further configured to determine the selected battery as a first battery of the batteries stored at the battery swap station with at least a threshold level state of charge and with a least number of charge cycles previously performed. In some embodiments, the selected battery is determined based on both the charge state of the batteries and the number of charge cycles previously performed on the batteries.

In some embodiments, the server is further configured to: receive updated user permissions provided via an administrator application; and using the updated user permissions, update access permissions defining which users have access to the batteries stored at the battery swap station. In some embodiments, the server is further configured to: generate a record of battery and battery swap station properties; and provide the record for presentation using an administrator application.

In some embodiments, the server is further configured to provide maintenance commands for use by the controller of the battery swap station, the maintenance commands comprising one or more commands from the group consisting of: a command to start loading a charging compartment of the battery swap station, a command to open a charging compartment of the battery swap station, a command to reset an error at the controller of the battery swap station, a command to restart the controller of the battery swap station, a command to bring the battery swap station offline, and a command to block access to or use of a charging compartment of the battery swap station. In some embodiments, the server is further configured to provide an alert to be viewed via an administrator application.

In some embodiments, the battery swapping system further includes the controller of the battery swap station, wherein the controller of the battery swap station is configured to: responsive to the command provided by the server, unlock or open the compartment storing the selected battery; confirm that the selected battery has been removed from the compartment; confirm that a discharged battery has been placed in the compartment and that the compartment has been closed; lock the compartment; confirm that the discharged battery can be recharged; begin charging the discharged battery placed in the compartment; and cause display of a notification indicating that the battery swap is complete.

In some embodiments, the battery swapping system further includes the user device, wherein the user device is configured to display a list of battery swap stations within a geographical region of the user device and batteries available at each battery swap station.

In another aspect of the present disclosure, a method includes, by a server in communication with a battery swap station storing batteries and a user device: receiving a request provided at a user device to perform a battery swap at a battery swap station storing batteries; determining a selected battery to provide in the requested battery swap based on one or both of a charge state of the batteries stored in the battery swap station and a number of charge cycles previously performed on the batteries stored at the battery swap station; and providing a command instructing the battery swap station to allow a door to open of a compartment storing the selected battery.

In some embodiments, the method further includes confirming that a requester associated with the request is within a threshold distance of the battery swap station before providing the command. In some embodiments, the method further includes determining that the battery swap station can complete the requested battery swap before providing the command. In some embodiments, the method further includes determining that a requester associated with the request is allowed to complete the requested battery swap before providing the command. In some embodiments, the method further includes determining the selected battery as a first battery of the batteries stored at the battery swap station with at least a threshold level state of charge and with a least number of charge cycles previously performed. In some embodiments, the determination of the selected battery is based on both the charge state of the batteries and the number of charge cycles previously performed on the batteries.

In some embodiments, the method further includes: receiving updated user permissions provided via an administrator application; and using the updated user permissions, updating access permissions defining which users have access to the batteries stored at the battery swap station. In some embodiments, the method further includes: generating a record of battery and battery swap station properties; and providing the record for presentation using an administrator application.

In some embodiments, the method further includes providing maintenance commands for use by the battery swap station, the maintenance commands comprising one or more commands from the group consisting of: a command to start loading a charging compartment of the battery swap station, a command to open a charging compartment of the battery swap station, a command to reset an error at the battery swap station, a command to restart a controller of the battery swap station, a command to bring the battery swap station offline, and a command to block access to or use of a charging compartment of the battery swap station. In some embodiments, the method further includes providing an alert to be viewed via an administrator application.

In some embodiments, the method further includes: responsive to the command, unlocking or opening the compartment storing the selected battery; confirming that the selected battery has been removed from the compartment; confirming that a discharged battery has been placed in the compartment and that the compartment has been closed; locking the compartment; confirming that the discharged battery can be recharged; beginning to charge the discharged battery placed in the compartment; and displaying a notification indicating that the battery swap is complete.

In some embodiments, the method further includes displaying a list of battery swap stations within a geographical region of the user device and batteries available at each battery swap station.

In another aspect of the present disclosure, a device is provided for swapping a discharged universal swappable battery at a battery swap station for a charged universal swappable battery. The device includes: a network interface in communication with a server communicatively coupled to a controller of the battery swap station; and a processor coupled to the network interface, the processor configured to: cause display of a list of battery swap stations within a geographical region associated with the device and information regarding batteries available at each battery swap station of the list; receive an indication of a selected swap station from the list of battery swap stations; provide a request to the server indicating the selected swap station, a number of batteries requested, and an identity of a user of the device; responsive to the request being granted, provide an initiation request to open a charging compartment storing the charged universal swappable battery.

In some embodiments, the processor is further configured to provide location information to the server to confirm the user is within a threshold distance of the selected swap station before the charging compartment storing the charged universal swappable battery can be opened.

In some embodiments, the processor is further configured to, responsive to the request not being granted, receive an alert indicating a battery swap is not allowed.

In another aspect of the present disclosure, a device is provided for managing a plurality of battery swap stations, each swap station storing swappable batteries. The device includes: a network interface in communication with a server communicatively coupled to the plurality of battery swap stations, the network interface configured to receive battery and battery swap station properties of the plurality of battery swap stations; and a processor coupled to the network interface, the processor configured to: cause display of a list of the plurality of battery swap stations managed by the device; receive a selection of a selected battery swap station from the list; in response to the selected of the selected battery swap station, cause display of battery and battery swap station properties of the selected battery swap station; receive a maintenance command to perform at the selected battery swap station; and provide the maintenance command to the server for transmission to the selected battery swap station.

In some embodiments, the maintenance command comprise one or more commands from the group consisting of: a command to start loading a charging compartment of the battery swap station, a command to open a charging compartment of the battery swap station, a command to reset an error at the battery swap station, a command to restart a controller of the battery swap station, a command to bring the battery swap station offline, and a command to block access to or use of a charging compartment of the battery swap station.

In some embodiments, the network interface is further configured to receive an updated record of battery and battery swap station properties for the selected battery swap station selected by a user of the device; and the processor is further configured to cause display of the updated record of battery and battery swap station properties.

In some embodiments, the processor is further configured to receive updated user permissions indicating a change in which users have access to the plurality of batteries stored at the selected battery swap station; and the network interface is further configured to provide the updated user permissions to the server to update permissions for accessing batteries at the selected battery swap stations.

### BRIEF DESCRIPTION OF THE DRAWINGS

Non-limiting and non-exhaustive examples are described with reference to the following figures.

FIGS. 1A-1D are diagrams of an exemplar swappable universal battery of this disclosure from various perspectives;

FIG. 2 is a diagram depicting an exemplar swappable universal battery from a front view;

FIG. 3 is a diagram depicting an exemplar swappable universal battery from a rear view;

FIG. 4 is a diagram depicting an exemplar swappable universal battery from a bottom view;

FIG. 5 shows a view of a bottom plug of an exemplar swappable universal battery;

FIG. 6 shows an exemplar connector for the bottom plug of FIG. 5;

FIG. 7 shows a view of the display, handle, and top plug of an exemplar swappable universal battery;

FIG. 8 is a diagram illustrating dimensions of an exemplar swappable universal battery;

FIG. 9A is a block diagram illustrating exemplar control circuitry (e.g., a battery management system) of a swappable universal battery;

FIG. 9B shows exemplar connections of control circuitry (e.g., a battery management system) of a swappable universal battery;

FIG. 10A is a flowchart illustrating an exemplar process for operating a swappable universal battery;

FIG. 10B is a flowchart illustrating another exemplar process for operating a swappable universal battery;

FIG. 11A is diagram of an exemplary charging/swapping station from a front view;

FIG. 11B is diagram of an exemplary charging/swapping station from a bottom view;

FIG. 11C is diagram of an exemplary charging/swapping station from a side view;

FIG. 11D is diagram of an exemplary charging/swap station from an angled view;

FIG. 11E is diagram of an exemplary charging/swap station from a back view;

FIG. 12 shows the inside of a charging compartment of an exemplar charging/swap station;

FIG. 13A shows control equipment that is accessible from the back of the exemplar charging/swap station of FIG. 12 with the rear doors open. FIG. 13B is a block diagram illustrating exemplar hardware of a compartment controller and/or a station controller in communication with other system components of FIG. 13A;

FIG. 14A is a diagram illustrating an exemplar universal interchangeable battery swap adapter from a front view;

FIG. 14B is a diagram illustrating an exemplar universal interchangeable battery swap adapter from a rear view;

FIG. 14C is a block diagram illustrating an exemplar battery switching controller of the battery swap adapter of FIGS. 14A and 14B;

FIG. 14D is a flowchart illustrating an exemplar process for operating a universal interchangeable battery swap adapter;

FIG. 15A is a diagram of an exemplar battery swapping system of this disclosure;

FIG. 15B is a block diagram illustrating an exemplar server of the battery swapping system of FIG. 15A;

FIG. 15C is a block diagram illustrating an exemplar administrator device of the battery swapping system of FIG. 15A;

FIG. 15D is a block diagram illustrating an exemplar operator device of the battery swapping system of FIG. 15A;

FIG. 16 is a flowchart illustrating an exemplar process for swapping a battery by a vehicle operator prospective;

FIG. 17 shows an exemplar view of a vehicle operator mobile application during the exemplar process of FIG. 16; and

FIG. 18 is a flowchart illustrating an exemplar process for implementing a battery swap using the system of this disclosure.

### DETAILED DESCRIPTION

The following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. The following detailed description is therefore not to be taken in a limiting sense, and the scope of the present disclosure is defined by the appended claims and their equivalents.

### 1. Swappable Universal Battery

This disclosure provides a swappable universal battery that can be used to power a range of electric vehicles, such as, for examples, e-scooters, electric bicycles, scooters, cars, cargo vans, golf carts, and others. Certain vehicles may be powered by a single battery, while larger vehicles may be powered by multiple batteries. One or more backup or redundant batteries may be used in a vehicle to provide power when needed (e.g., in the case of a battery failure or loss of charge, as described further below). When the battery (or batteries) used in a given electric vehicle are discharged or nearly discharged (e.g., less than 20% of capacity), the battery or batteries may be removed and replaced with more fully charged batteries of the same design. The swappable universal battery fits into an adaptor on or within the electric vehicle, and it also fits within a battery charger (e.g., a compartment of the charging/swap station included in the battery ecosystem). The swappable universal battery provides a flexible and efficient solution for a diverse range of electric vehicles, which can be designed or retrofitted to be powered by one or more of the swappable universal batteries.

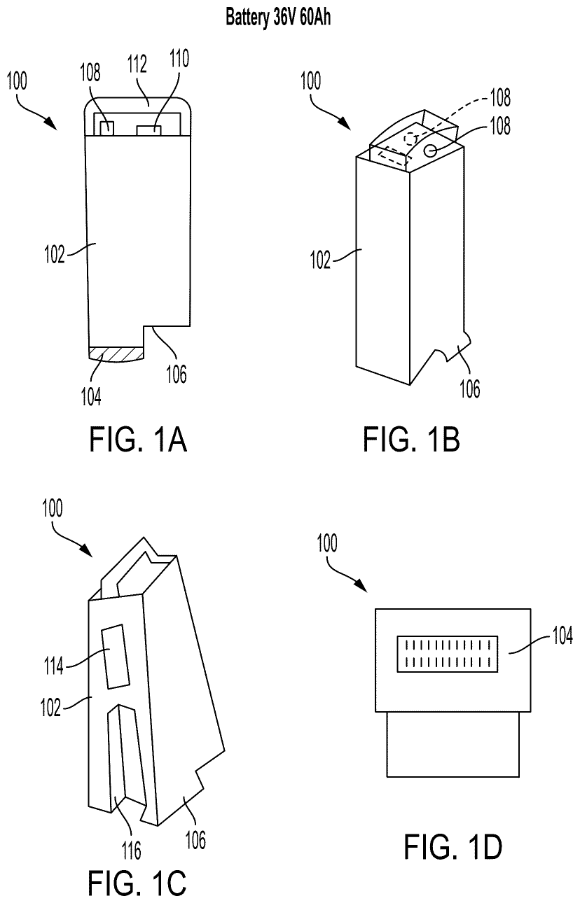

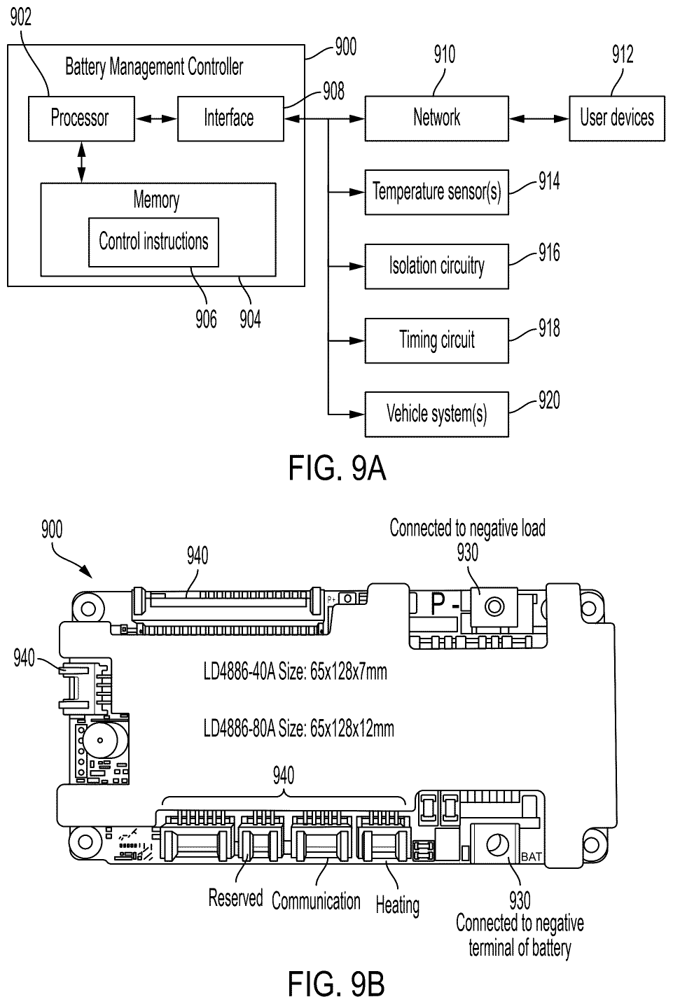

FIGS. 1-5 and 7-8 illustrate examples of various features of the swappable universal batteries of this disclosure. In the exemplar battery 100 shown in these figures, a housing 102 holds one or more battery cells and control circuitry (see, e.g., FIGS. 9A and 9B) that store control logic to implement a battery management system (BMS). The housing 102 is generally made of a durable material (e.g., ABS plastic or a similarly robust material) to provide durability in case of impacts. Any appropriate battery cells may be used. For example, the swappable universal battery 100 may utilize a set of 10 blade lithium-ion cells. The swappable universal battery 100 may be a 36 V/60 Ah battery. However, the swappable universal battery 100 can have a different capacity as needed for a given application. Technical specifications of an example swappable universal battery 100 are provided in the Table below.

TABLE
Technical specifications of an exemplar
swappable universal battery

| Items | Specifications | |
|---|---|---|
| Nominal capacity | 60000 mAh @0.5 C discharge | |
| Min Capacity | 60000 mAh @ 1 C discharge | |
| Nominal voltage | 36 | V |
| Charge voltage | 42 | V |
| Charge current | Standard charge: 0.2 C Rapid charge | |
| Standard Charging method | 0.2 C 42 V, 42 V 0.05 C | |
| Charging time | Standard charge: 350 min (Ref.) | |
| | Rapid charge: 150 min (Ref.) | |
| Max. charge current | 1 | C |
| Max. continuous discharge current | 80 | A |
| Max. instant discharge current | 2 | C |
| Discharge cut- off voltage | 30 | V |
| Operating temperature | Charging: 0° C.~45° C. | |
| Storage temperature | −20° C.~70° C. | |
| for a long time | 60 ± 25% R.H. | |
| Internal resistance | ≤50 | mΩ |

| | |
|---|---|
| Weight | Approx 12 ± 0.2 kg |
| Shipment Voltage | ≥13 V |
| and SOC | 19%~30% |

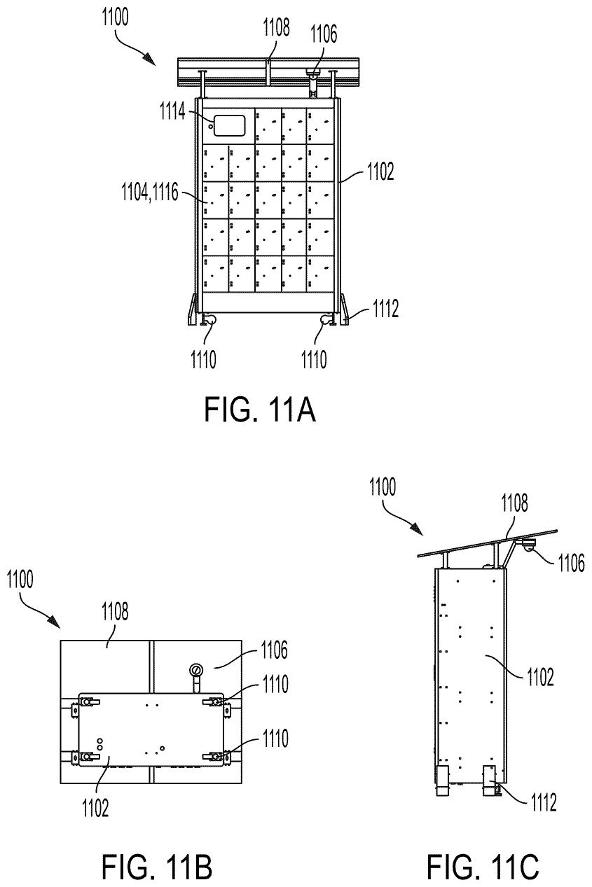

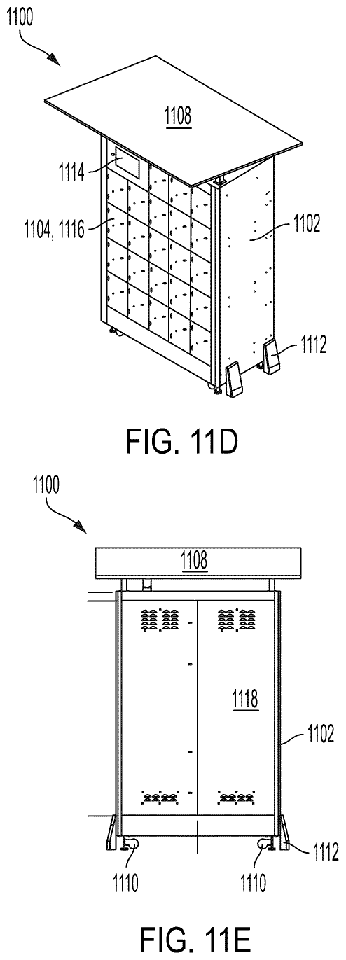

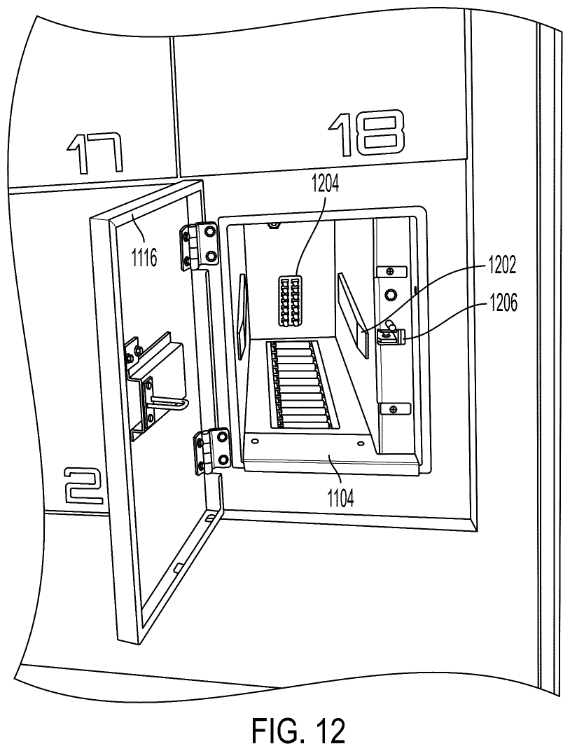

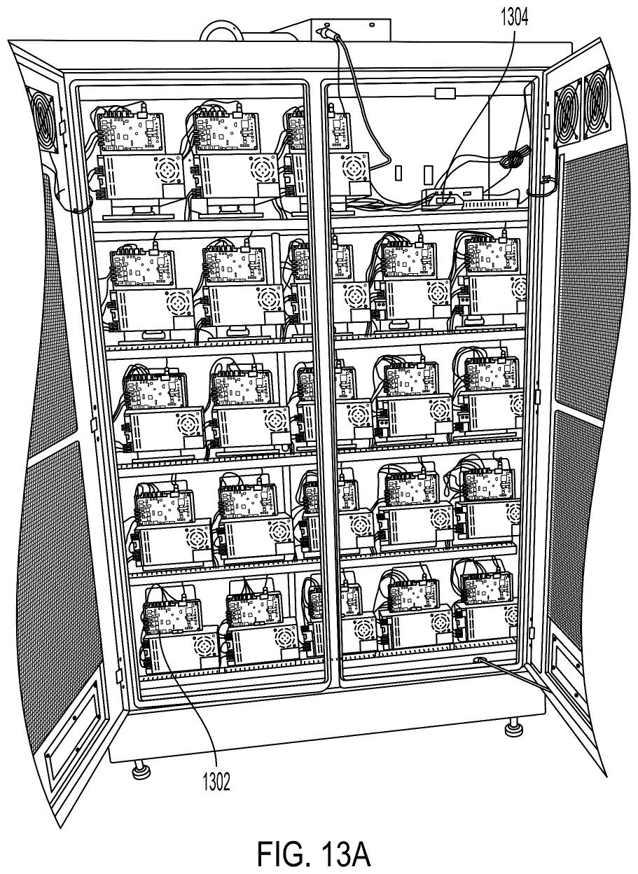

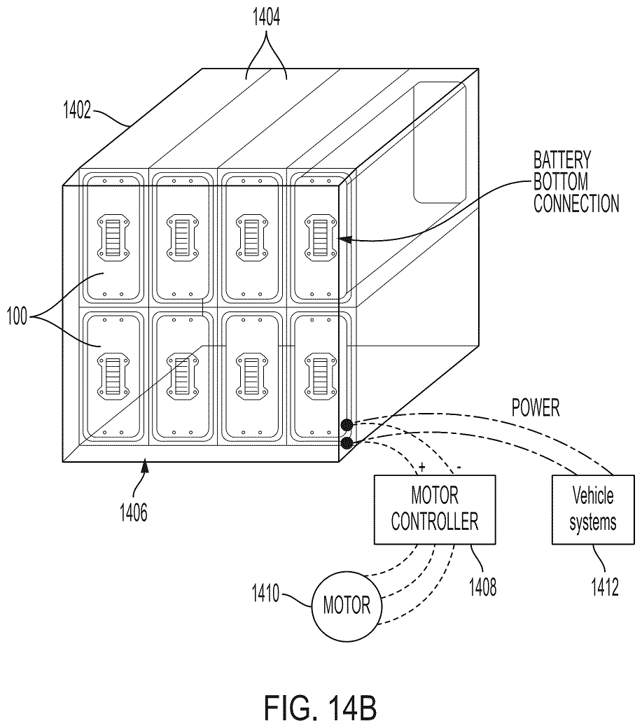

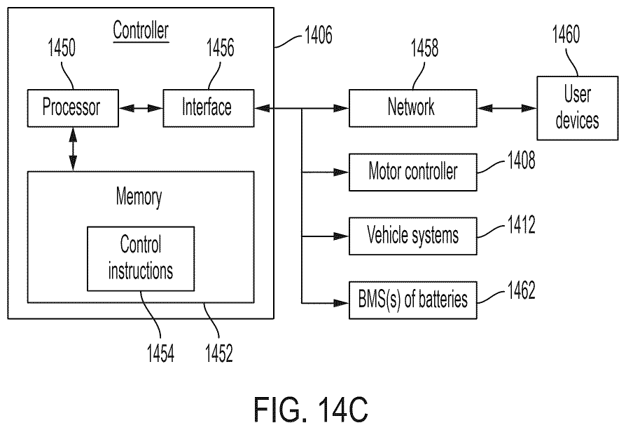

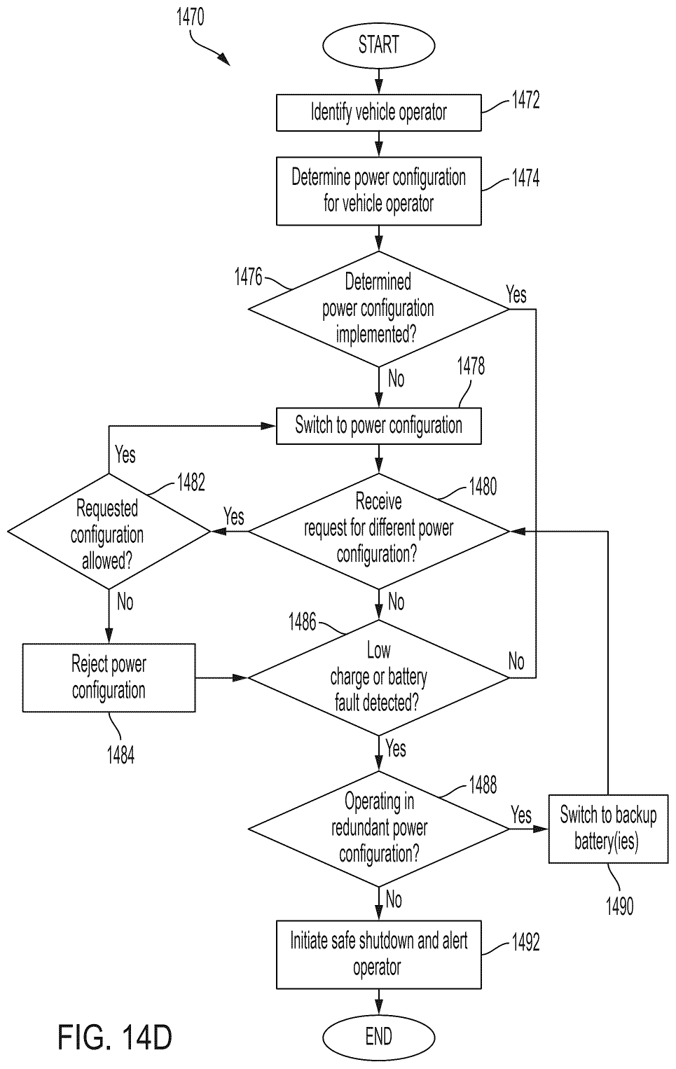

As shown in FIGS. 1, 2, and 4, the housing 102 of the swappable universal battery 100 may include an alignment slot 114 and a locking mechanism 116 that facilitate proper and secure positioning of the battery 100 in an electric vehicle (see, e.g., FIGS. 14A and 14B) and in the charging compartment of a charger (e.g., of a charging/swap station, as shown in examples of FIGS. 11A-12). The alignment slot 114 may aid in guiding the battery 100 into an appropriate position for powering an electric vehicle and for recharging in a charging/swap station. The locking mechanism 116 helps hold the properly positioned battery 100 in place.

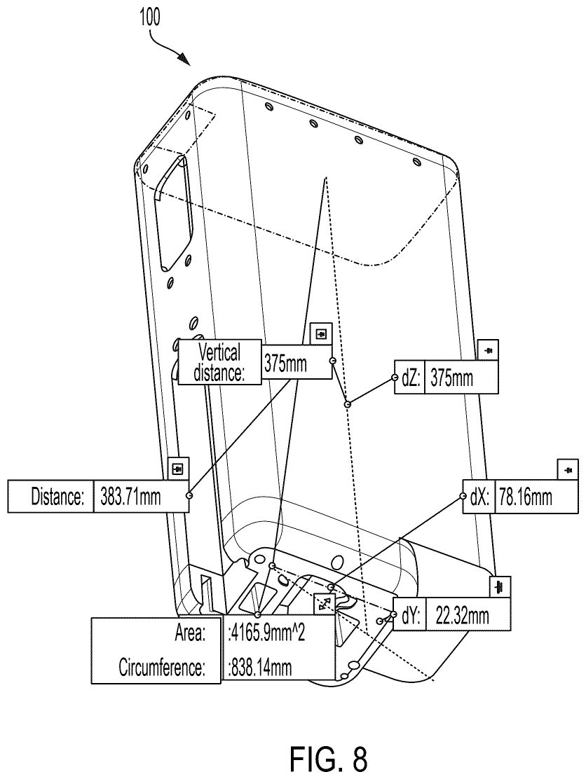

The swappable universal battery 100 may be sized and shaped to facilitate easy battery swapping by most users. The battery 100 generally includes a handle 112 that allows a user to lift and move the battery (e.g., between an electric vehicle and a charger). The swappable universal battery 100 also has physical dimensions and a weight that enables most users to lift, carry, and position the battery in an electric vehicle and in the charging compartment of a charging/swap station. For example, a swappable universal battery 100 may have a height of about 375 millimeters (mm), a depth of about 100 mm, and a length of about 175 mm. The weight of a swappable universal battery 100 may be about 11 kg. FIG. 8 also provides labeled dimensions of an example swappable universal battery 100. These examples of battery dimensions and weight are provided for illustration only. Other physical dimensions and weight may be used, as long as most users, or a typical user, can lift the battery 100 relatively easily to swap out the battery 100 when needed.

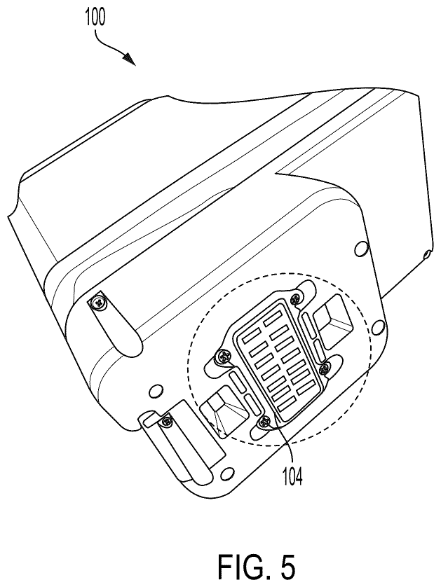

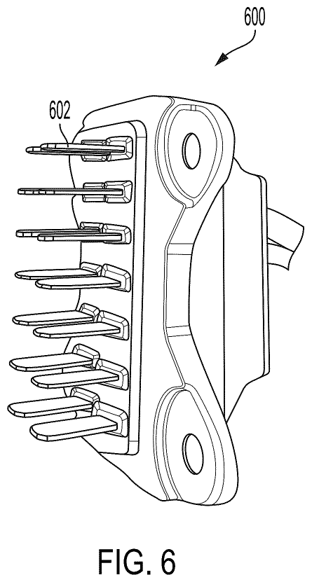

As shown in the example of FIG. 1, the swappable universal battery 100 has strategically placed connector plugs 104, 108 that allow the battery 100 to be connected to different types of vehicle. For instance, at the bottom surface 106 of the battery 100, there is a plug 104 that may serve the dual functions of connecting to a charging/swap station for charging and connecting to a smaller electric vehicle, such as an e-scooter or electric bicycle. FIG. 5 provides a more detailed view of the bottom plug 105 on an example swappable universal battery 100, and FIG. 6 shows an example connector 600 for connecting to this bottom plug 104 (e.g., in a battery charger or in an electric vehicle). The example connector 600 of FIG. 6 includes a plurality of prongs 602 for power and, in some cases, data transmission between the battery 100 and the electric vehicle being powered (as well as between a charging/swap station and the battery during charging).

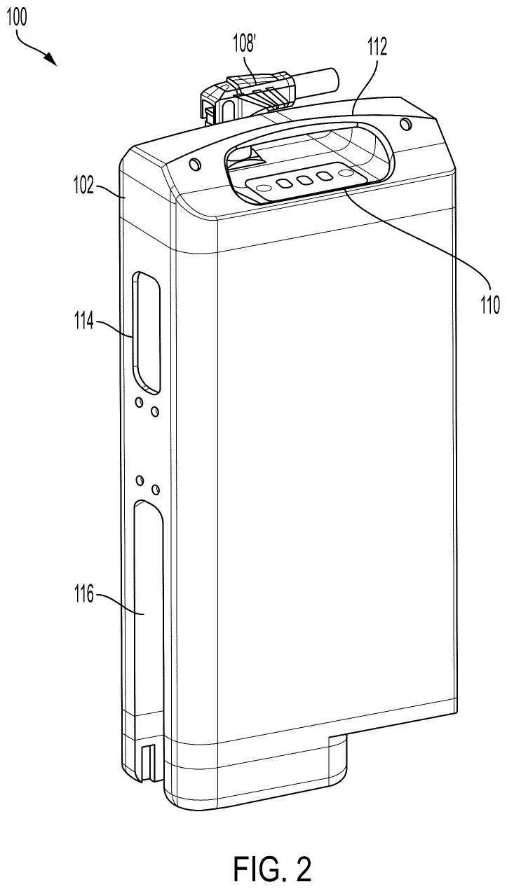

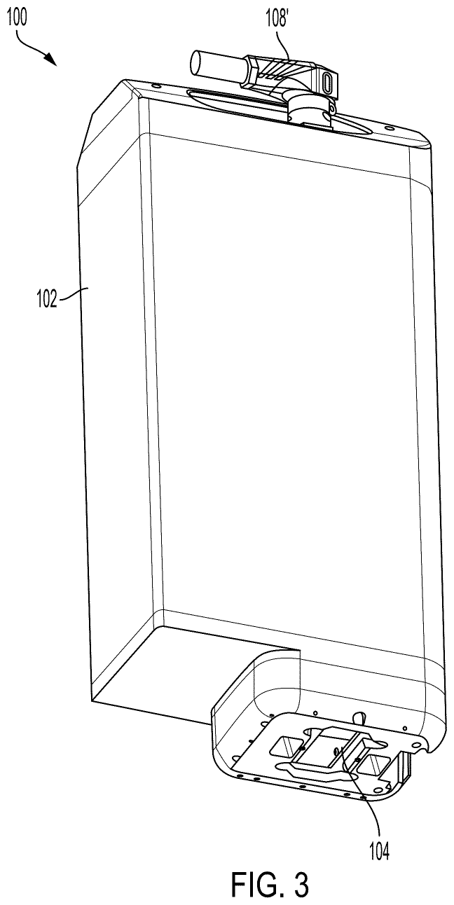

At the top of the exemplar swappable universal batteries 100 shown in FIGS. 1-5 and 7, there are two additional connector plugs 108 used for power output. A special dedicated jack 108′ can be connected to the top plugs 108 (see example jack 108′ connected to the top of the battery 100 in FIGS. 2 and 3) and used to power electric vehicles that require more than two batteries 100, such as larger scooters, cars, and similar vehicles.

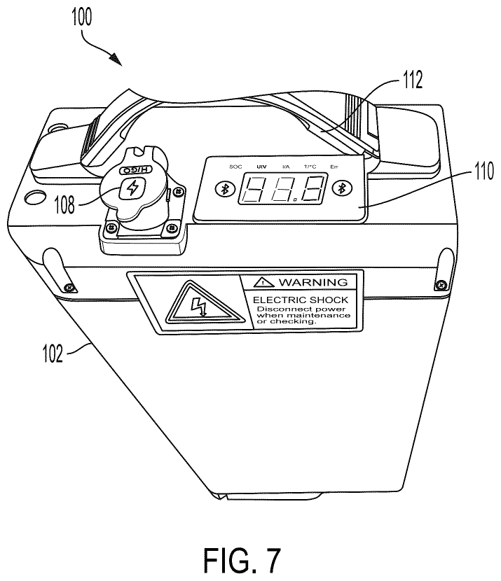

As shown in FIGS. 1, 2, and 7, the swappable universal battery 100 may include an electronic display 110. For example, in FIG. 7, the display 110 may show various properties of the battery 100, such as battery state of charge (SOC), battery voltage, battery current, battery temperature, error status, and wireless connection status (e.g., a light behind the Bluetooth symbol may turn on or off to indicate connection status in the example display of FIG. 7). A button may be located on or near the display to cycle through the available battery properties and/or to turn the display on or off.

The housing 102 also contains a battery controller or battery management system (BMS), which includes control circuitry, such as one or more processors, memory, and input/output interfaces, to control the operations of the swappable universal battery and communicate with other devices. FIGS. 9A and 9B show an exemplar controller 900 used to implement a BMS. As shown in the block diagram of FIB. 9A, the controller 900 includes a processor 902, memory 904, and communication interface 908. The processor 902 processes and/or executes code and/or other instructions (e.g., control instructions 906). The processor 902 may include one or more processors, which may be specialized processors configured to execute the control instructions 906 in any appropriate format.

The memory 904 stores any data, instructions, logic, rules, and/or code necessary for executing the functions of controller 900. The memory 904 may store control instructions 906, which consists of the code needed for implementing the various functions described in this disclosure. The memory 904 may include one or more disks, tape drives, or solid-state drives, and can serve as an over-flow data storage device, storing programs when they are selected for execution, as well as instructions and data that are read during program execution. The memory 904 may be volatile or non-volatile and may comprise read-only memory (ROM), random-access memory (RAM), ternary content-addressable memory (TCAM), dynamic random-access memory (DRAM), and/or static random-access memory (SRAM).

The communication interface 908 enables wired and/or wireless communication between the battery management controller 900 and other components. For example, the communication interface 908 may transmit data between the controller 900 and a user device 912 (via network 910), one or more temperature sensors 914 configured to measure a temperature of the battery 100, isolation circuitry 916 of the battery 100 (e.g., used to efficiently isolate the battery 100 from a load, as described elsewhere in this disclosure), a timing circuit 918 (e.g., used to synchronize battery switching tasks, as described elsewhere in this disclosure), and/or other vehicle system(s) 920 (e.g., to allow display of battery data on an in-vehicle display).

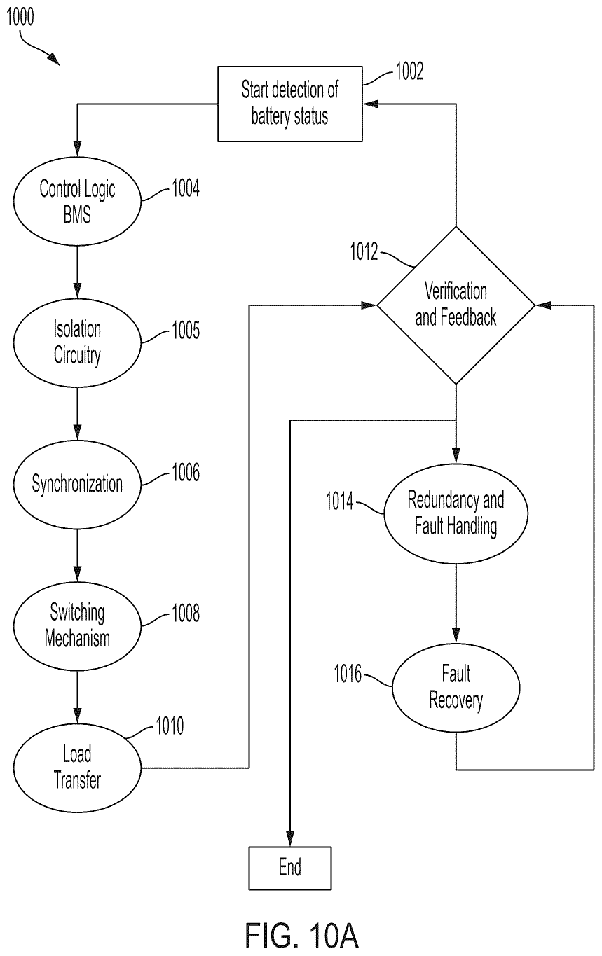

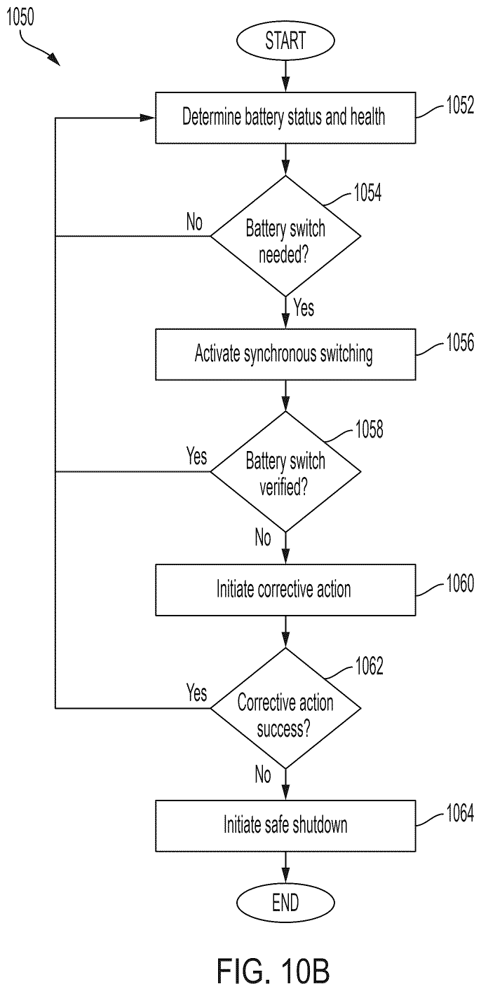

The communication interface 908 may also facilitate communication with other swappable batteries to enable and synchronize switching between batteries used to power a vehicle (see, e.g., FIGS. 10A and 10B and corresponding description below). The communication interface 908 may include one or more serial ports (e.g., USB ports or similar) and/or parallel ports (e.g., any type of multi-pin port) for facilitating this communication. Additionally, the communication interface 908 may include a WIFI interface, a local area network (LAN) interface, a wide area network (WAN) interface, a modem, a switch, or a router. The processor 902 is configured to send and receive data using the communication interface 908, which may be configured to use any suitable type of communication protocol.

The exemplar controller 900 of FIG. 9B includes connections 930 to the load and the battery terminals, along with ports 940 for wireless communication (via 4G cellular communication in this example), as well as other communication and heating functions. These various ports 940 and connections 930 generally correspond to components of the interface 908 shown in FIG. 9A. This example controller 900 uses control area network (CAN) communication, though other communication protocols can also be used. In some cases, the BMS controller 900 uses RS485 communication for reliable and accurate battery health monitoring, as described in further detail below.

As also described below with respect to example battery operation, the controller 900 of the swappable universal battery 100 may incorporate more advanced electronic components, such as metal-oxide-semiconductor field-effect transistors (MOSFETs) and solid-state switches, in place of conventional electronic relays. These advanced components may provide faster response times, lower power losses, and improved reliability compared to traditional relay-based systems.

As described above, the BMS controller 900 may include circuitry for wireless communication, such as through cellular networks, Bluetooth, Wi-Fi, and/or other similar technologies, allowing battery information and/or controls to be transmitted between the battery and an external device, such as user device 912. For example, the battery 100 may communicate with a mobile device, such as a smartphone, belonging to an operator of an electric vehicle powered by the battery 100. The mobile device can display properties of the battery (e.g., similar to those available on the battery's display, but more easily accessible while operating the vehicle). This information may enable the operator to proactively switch to a redundant battery or plan battery swapping activities (e.g., finding a local charging/swap station and confirming a battery is available at the station).

Wireless communication may be used to send alerts to the operator's device when a battery swap will be needed in the future (e.g., when a certain state of charge is reached and/or based on recent driving and/or battery usage trends). The battery 100 may also communicate with a charger (e.g., a charging/swap station) used to charge the battery 100. For example, the battery's temperature, state of charge, and other parameters may be provided to the charging/swap station, which can then use this information to adjust charging parameters. For example, if a battery is at too high a temperature, a slower charging schedule may be implemented to increase the battery's longevity.

### Example Battery Management and Operation

In addition to providing the improved battery described above with respect to FIGS. 1-9B, this disclosure also provides improved processes for battery operation and management. These improved processes offer several advantages, including:
1. Comprehensive Integration: The technology disclosed integrates a series of essential components and functionalities into a cohesive system, including battery status detection, control logic, isolation circuitry, synchronization, switching mechanisms, load transfer, verification and feedback, redundancy, and fault recovery. This comprehensive integration provides a holistic approach to power management, enhancing overall system efficiency and reliability.
2. Enhanced Fault Tolerance: Unlike some previous systems that may lack robust fault detection and recovery mechanisms, the swappable universal battery described in this disclosure incorporates advanced fault handling capabilities. By continuously monitoring the health of two or more batteries in a multi-battery vehicle and automatically switching to a redundant battery in the event of a fault, the technology of this disclosure facilitates uninterrupted vehicle operation and enhances overall safety.
3. Improved Isolation Circuitry: Previous technologies generally relied on conventional isolation components, such as electronic relays. In contrast, the swappable universal battery of this disclosure uses advanced technologies such as MOSFETs and solid-state switches for isolation functions. These components provide faster response times, lower power losses, and improved reliability compared to traditional relay-based systems.
4. Seamless Load Transfer: The swappable universal battery described in this disclosure is managed using a process that facilitates smooth load transfer between battery sources, minimizing disruptions to vehicle operation and ensuring uninterrupted power supply. This seamless transition is achieved through precise synchronization and control logic, improving vehicle performance and user experience.
5. Efficient Power Management: By employing sophisticated control algorithms and monitoring parameters, such as voltage, current, and temperature, electric vehicles can achieve improved power distribution and utilization. This leads to improved energy efficiency, extended battery life, and reduced operating costs compared to previous systems.

FIG. 10A shows a flowchart of an exemplar process 1000 for electronically switching between two batteries (e.g., an active battery being used to power a vehicle and a redundant or backup battery). This process may offer some or all of the advantages summarized above. It involves several steps to ensure a smooth transition between batteries and reliable vehicle operation.
1. Detection of battery Status 1002: The system's main controller (e.g., a control circuit or microcontroller in communication with each battery's BMS) detects the status of all batteries to determine which one is currently active and whether all batteries are operational.
2. Control Logic 1004: The controller manages the battery switching process. The control logic circuit or microcontroller receives inputs from the batteries' BMSs and determines when and how to switch between the batteries.
3. Isolation Circuitry 1005: To prevent or reduce the possibility of voltage spikes or surges from damaging the system during battery switching, isolation circuitry such as relays, MOSFETs, or solid-state switches may be used. These components ensure that the switching process is electrically isolated from the rest of the system.
4. Synchronization 1006: The switching process is synchronized with the system's operation to avoid interruptions or glitches. This synchronization may be achieved using timing circuits or synchronization signals from the system's main controller.
5. Switching Mechanism 1008: Once the controller determines that a switch is necessary, the switching mechanism is triggered. This involve opening or closing relays, activating MOSFETs, or controlling other switching devices.
6. Load Transfer 1010: During the switching process, the load is smoothly transferred from one battery to another to ensure uninterrupted power to the vehicle.
7. Verification and Feedback 1012: After the switch, the system verifies the stability and quality of the new power source. This can involve monitoring parameters such as voltage, current, and/or temperature to ensure that they are within predefined operating limits. Feedback from these measurements is used to confirm the success of the switch or to trigger any necessary corrective actions.
8. Redundancy and Fault Handling 1014: The control logic continuously monitors the health of the batteries. If a fault is detected in the active battery, the system automatically switches to the redundant battery without disruption.
9. Fault Recovery 1016: If a fault occurs during the switching process or while using one of the batteries, the system will safely shutdown.

FIG. 10B shows a flowchart of another exemplar process 1050 for electronically switching between two batteries (e.g., an active battery being used to power a vehicle and a redundant or backup battery). Process 1050 may begin at step 1052, where the controller 900 determines the status of the battery being used to power the vehicle. The status of the in-use battery may include its health, state of charge (SOC), temperature, and/or other characteristics of the battery currently powering the vehicle.

At step 1054, the controller 900 determines whether switching to the second battery is necessary based on the status from step 1052. For example, the controller 900 may determine the need to switch to the backup battery if the charge of the in-use battery falls below a threshold level. As another example, the controller 900 may determine that switching to the backup battery is required if the temperature of the in-use battery exceeds a threshold value or falls outside a threshold temperature range. As another example, the controller 900 may detect a fault in the in-use battery (e.g., based on voltage, current, or other properties of the battery) to justify switching. If switching is not needed, the controller 900 returns to step 1052. Otherwise, if switching is needed, the controller 900 proceeds to step 1056.

At step 1056, the controller 900 initiates synchronous switching from the in-use battery to the backup battery. In other words, the controller 900 synchronously causes the backup battery to begin powering the electric vehicle while electronically isolating the in-use battery from the electric vehicle. Synchronous battery switching may be performed by generating a synchronization signal (e.g., generated by the timing circuit 918) that is shared by both the in-use battery and the backup battery. At a predefined time indicated by the synchronization signal, a relay (e.g., isolation circuitry 916) connecting the in-use battery to the power systems of the electric vehicle is opened (e.g., electronically disconnected), thereby isolating the in-use battery from the electric vehicle. Simultaneously, a relay of the backup battery connecting the backup battery to the power systems of the electric vehicle is closed (e.g., electronically connected), allowing the backup battery to power the electric vehicle. The synchronization signal may be generated by a timing circuit in communication with the first battery and the second battery.

At step 1058, the controller 900 confirms whether the battery switch was successful (i.e., whether the battery switching process completed as intended). If so, the controller 900 returns to step 1052 and continues to monitor the health of the backup battery. which is not in use for powering the vehicle. If the switch was not successful, the controller 900 proceeds to step 1060 to initiate one or more corrective actions. For example, the controller 900 may repeat the automatic switching procedure described above one or more times. As another example, the controller 900 may provide an alert on a display of the vehicle and/or on the operator's device, indicating that a manual battery switch is needed. The operator can then perform manual operations, such as using a control interface on the vehicle's display or the operator's device to switch the battery. In some cases, the operator may stop the vehicle and manually switch batteries in a safe location.

At step 1062, the controller 900 determines whether the corrective action was successful. If this is the case, the controller 900 returns to step 1052 and continues to monitor the health of the backup battery which is not in use for powering the vehicle. If this is not the case, the controller 900 proceeds to step 1064 and initiates a safe shutdown of the vehicle. For instance, the controller 900 may display a warning indicating that a safe shutdown is imminent and provide a period of time for the vehicle to be moved to a safe location for the shutdown. Service providers may be automatically informed of the imminent shutdown along with information about the vehicle and its location, allowing for proactive and efficient corrective actions.

Although the process 1050 is described as being used to switch a single in-use battery with a single backup battery, the same or a similar process may be employed to switch between multiple in-use and backup batteries. While process 1050 is described as being performed by the controller 900 of a swappable battery, any other suitable control system may be used, such as a controller configured to operate a battery swap adapter (see, e.g., the battery swap controller 1406 of FIGS. 14B-14D). In some cases, the controllers of multiple batteries and/or of one or more battery swap controllers may perform one or more steps of process 1050.

### 2. Charging and Swap Station for Universal Electric Vehicle Batteries

FIGS. 11A-13 illustrate an exemplar charging and swap station 1100 (also referred to herein as a “charging/swap station” or simply a “station”) designed for use with the swappable universal batteries described above. The exemplar charging/swap station 1100 is a multi-battery, locker-style charging station. A network of charging/swap stations positioned at multiple locations allows for fast and efficient battery replacement within the network's area. A depleted battery can be rapidly and easily swapped for a charged battery (e.g., in less than 30 seconds), enabling operators to resume operations with significantly less downtime than is required for recharging conventional electric vehicles.

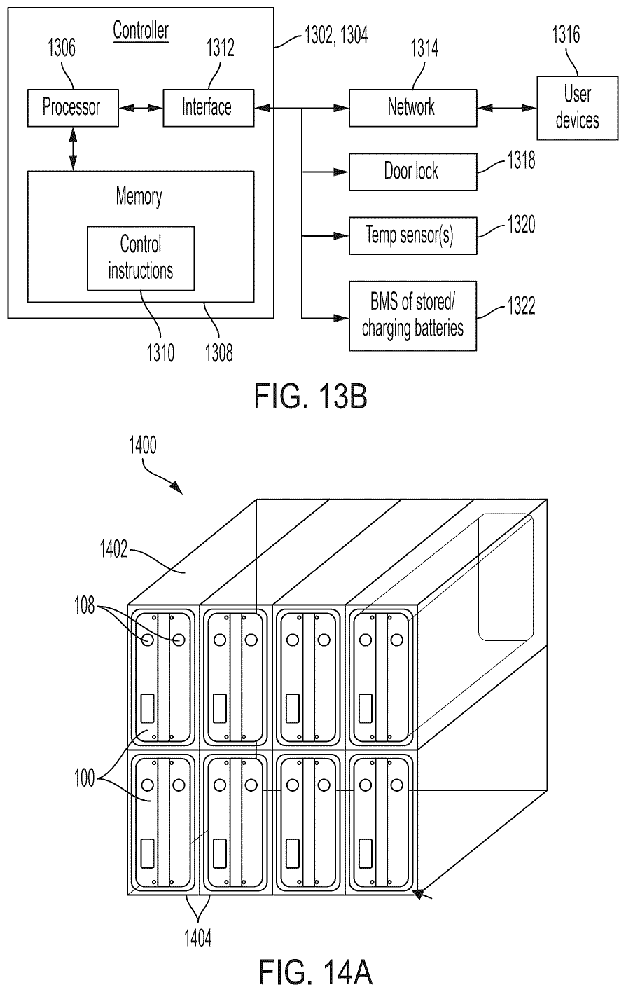

The charging/swap station 1100 includes a frame 1102 that forms a plurality of charging compartments 1104 (23 compartments in this example) in the front of the station (see FIG. 11A). Each charging compartment 1104 includes a lockable door 1116 that can be controlled (e.g., locked and unlocked) to grant access to charged batteries and facilitate battery recharging for verified users, as described further below. The rear of the station 1100 (see FIG. 11E) includes doors 1118 for accessing the rear of the compartments 1104 (e.g., to access control devices and other electronics shown in FIG. 13A).

The charging/swap station 1100 has a display 1114 (see FIG. 11A) that shows information about the charging/swap station 1100, its operations, and/or the batteries stored within it. As shown in FIGS. 11A-11E, the charging/swap station 1100 may be quasi-mobile (e.g., equipped with wheels 1110), allowing it to be easily moved to a desired location. The exemplar charging/swap station 1100 has legs 1112 that may be adjusted to a raised position to move the station 1100 and to a lowered position when the charging/swap station 1100 is at a desired location. The wheels 1110 can be locked in place at the desired location.

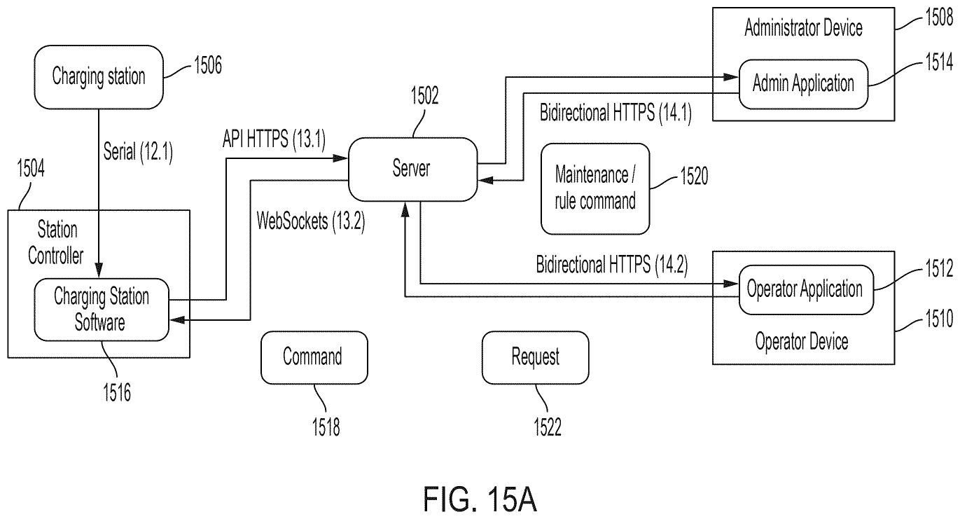

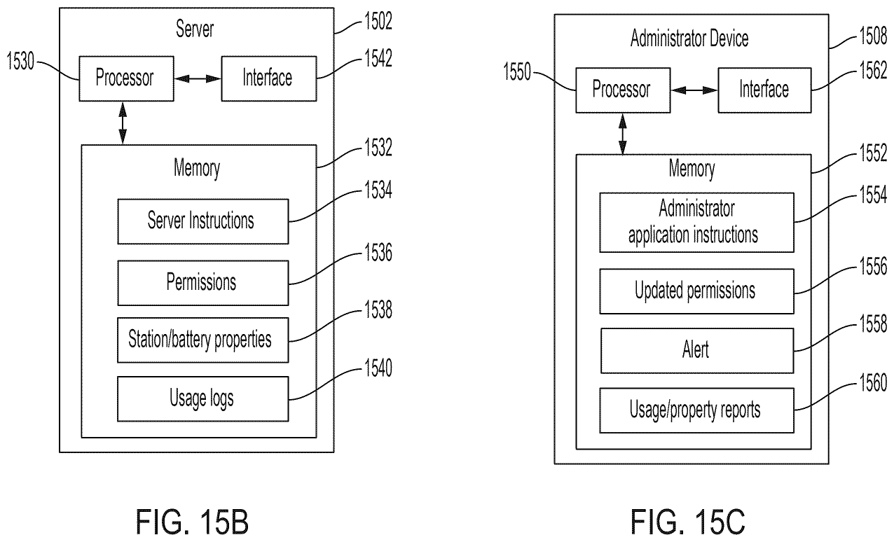

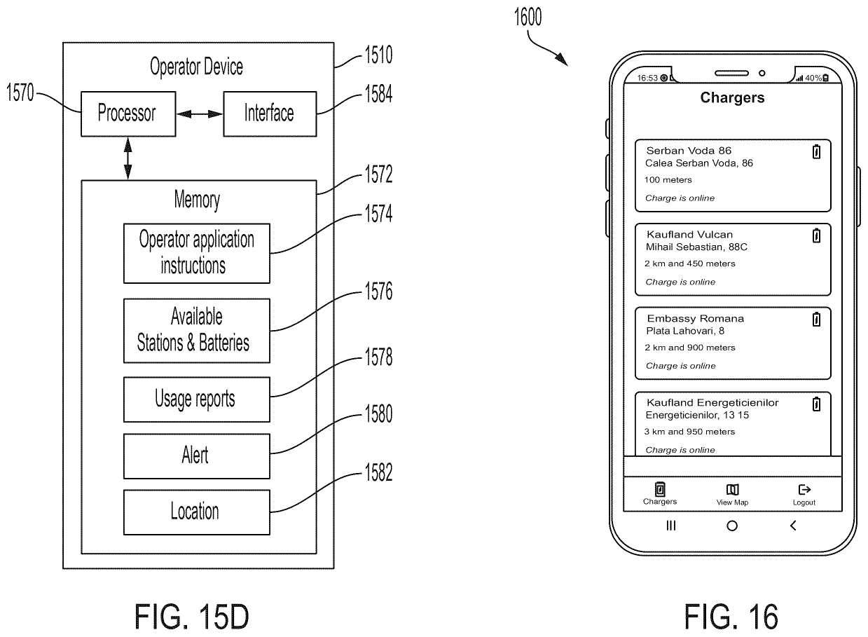

During such moves of the charging/swap station 1100 and/or during power outages, one or more of the batteries may be used to power basic functions of the charging/swap station 1100 (e.g., functions other than recharging the batteries). This allows the charging/swap station 1100 to continue operating by communicating with user and administrator devices (see FIG. 15A) and monitoring battery status during a move or power outage.

One or more solar panels 1108 may be installed on the top of the charging/swap station 1100, as shown in FIGS. 11A-11E, to provide longer-term, more continuous operation during power outages or moves. The solar panel(s) 1108 can recharge the battery or batteries used to provide backup power to the station 1100. As such, there may be little to no down time for users, even during extended power outages or moves of the station 1100. In some cases, a backup power source, such as a generator, may be used to recharge batteries during a power outage.

FIG. 12 shows the interior of a charging compartment 1104 of the exemplar charging/swap station 1100 of FIGS. 11A-11E. Each compartment 1104 is generally sized and shaped to receive a swappable universal battery (see FIGS. 1-9). For example, the compartment 1104 has dimensions—a height, width, and depth—that appropriately accommodate the swappable universal battery.

The compartment 1104 may include alignment guides1202, as shown in FIG. 12, which align with the alignment slot and/or locking mechanism of the battery (see, e.g., FIG. 1). At the rear of the compartment 1104 is a charging port 1204, equipped with a connector that is the same as or similar to that shown in FIG. 6. This connector connects to the bottom plug of the swappable universal battery and is also linked to a power source (e.g., a high voltage power source) to recharge the battery.

Each charging compartment 1104 may be fireproof or fire resistant. For example, each compartment 1104 may consist of a fireproof or fire-resistant container housed within the frame 1102 of the charging/swap station 1100. This design may help ensure that a fire caused by one battery does not lead to damage to other nearby batteries, objects, or people in the vicinity of the charging/swap station 1100.

When a charging compartment 1104 is to be accessed (e.g., to place a battery for charging and/or take a charged battery), the compartment 1104 is unlocked (see lock 1206 of FIG. 12). For instance, a user may send a request to access a charged battery. The user will then be assigned a battery with a sufficient charge. Batteries with an insufficient charge will not be released from the charging/swap station 1100. Upon arriving at the charging/swap station 1100, the user may request that the door 1116 be opened to the compartment 1104 containing the assigned battery. If the user is close enough to confirm their intent to take the charged battery, the lock 1206 is unlocked by the station controller (see FIG. 13A), allowing the door 1116 to be opened. The user can then remove the charged battery and place the discharged battery into the compartment 1104.

FIG. 13A shows a view of the rear side of the exemplar charging/swap station 1100 with the rear doors 1118 open, revealing various control and recharging circuitry. In the example of FIG. 13A, each compartment 1104 of the charging/swap station 1100 has its own compartment controller 1302. A station controller 1304 is connected to these controllers 1302 and provides instructions for the operation of the compartments 1104.

Both the compartment controllers 1302 and station controller 1304 generally include control circuitry (e.g., one or more processors, memory, and input/output interfaces-see FIG. 13B and corresponding description below) and associated control logic (e.g., stored in memory of the control circuitry) for performing the operations described in this disclosure. Other control configurations can also be used. While operations are sometimes described as separately being performed by a compartment controller 1302 or the station controller 1304, these operations can alternatively be performed by the same controller or through other control strategies or devices.

The station controller 1304 generally oversees the operations of the station 1100 and facilitates communication between the charging/swap station 1100 and external devices. For example, the station controller 1304 may receive information about the batteries stored in the station 1100 (e.g., directly from the batteries and/or the compartment controllers) and provide a record of these batteries and their information (e.g., charge state, serial number, etc.) for access by external devices. The station controller 1304 may also provide instructions for scheduling battery charging ensure that all batteries in the station 1100 are charged within an appropriate timeframe. The station controller 1304 may also manage access to the charging compartments 1104.

Meanwhile, the compartment controllers 1302 may oversee operations directly related to the battery stored and charged in each charging compartment 1104. For example, the compartment controllers 1302 may manage temperature control for each battery during charging and storage. Since batteries typically increase in temperature while charging, cooling may be employed to maintain the batteries within a desired temperature range during charging. In some cases, predefined charging schedules may be established for a given battery (e.g., as instructed by the station controller 1304 to facilitate improved battery availability). The compartment controller 1302 for a given battery can then adjust this charging schedule to keep the battery within the predefined temperature range (e.g., by reducing the charging rate when the battery temperature exceeds a threshold value).

FIG. 13B shows a block diagram of exemplar hardware of a compartment controller 1302 and/or station controller 1304, in communication with other system components. The controller 1302, 1304 of FIG. 13B includes a processor 1306, memory 1308, and communication interface 1312. The processor 1306 processes and/or executes code and/or other instructions (e.g., control instructions 1310). The processor 1306 may include one or more processors, which may be specialized processors configured to execute the instructions 1310 in any appropriate format.

The memory 1308 stores any data, instructions, logic, rules, and/or code necessary for the functions of controller 1302, 1304. The memory 1308 may store control instructions 1310, which encompass the code for implementing the various functions described in this disclosure. The memory 1308 may include one or more disks, tape drives, or solid-state drives, and can serve as an over-flow data storage device, storing programs selected for execution as well as instructions and data read during program execution. The memory 1308 can be volatile or non-volatile and may consist of read-only memory (ROM), random-access memory (RAM), ternary content-addressable memory (TCAM), dynamic random-access memory (DRAM), and/or static random-access memory (SRAM).

The communication interface 1312 enables wired and/or wireless communication between the controller 1302, 1304 and other components. For example, the communication interface 1312 may facilitate data exchange between the controller 1302, 1304 and various entities, including a user device 1316 (via network 1314), a door lock 1318 (e.g., door lock 1206 of FIG. 12), one or more temperature sensors 1320 configured to measure the temperature of a battery and/or a compartment 1104, and/or the BMSs (e.g., controller 900 of FIGS. 9A and 9B) of batteries stored in or otherwise in communication with the station 1100.

The communication interface 1312 may include one or more serial ports (e.g., USB ports) and/or parallel ports (e.g., any type of multi-pin port) to facilitate this communication. As another example, the communication interface 1312 may include a WIFI interface, a local area network (LAN) interface, a wide area network (WAN) interface, a modem, a switch, or a router. The processor 1306 is configured to send and receive data using the communication interface 1312, which can utilize any suitable communication protocol.

Referring again to FIGS. 11A-13B, in an example operation of the charging/swap station 1100, a driver of a vehicle with a swappable universal battery receives an alert on their mobile device 1316 indicating that a charged battery is needed. The system identifies local charging/swap stations near the driver and/or along their route. The driver can view a record of available batteries at each charging/swap station (e.g., to confirm that a charged battery is available). The station controller 1304 maintains a record of this information and provides it for viewing on the user's device 1316.

Upon arriving at the selected charging/swap station 1100, the driver removes the depleted battery from their vehicle and requests a new battery via their mobile device 1316 or by interacting with the station's display 1114. The charging/swap station 1100 then releases the lock 1206 on the compartment 1104 storing the charged battery, allowing the door 1116 to open. The user's device 1316 may need to be sufficiently near the charging/swap station 1100 (e.g., based on GPS positioning or Bluetooth) for the lock 1206 to be released.

The driver removes the charged battery and places it in their vehicle, then inserts the discharged battery into the now-empty compartment 1104 for recharging and reuse at another time (potentially for another driver and/or vehicle type). The charging/swap station 1100 then manages charging of the battery (e.g., by initiating an appropriate charging schedule and temperature controls, as described above).

In some cases, an administrator may oversee operation of the charging/swap station 1100 or an associated network of charging/swap stations. The administrator can access data about the charging/swap station 1100, adjust its operating parameters or permissions, and/or receive alerts related to its status. For example, the administrator may update a list of users authorized to access a specific charging/swap station 1100 by modifying the list available to the station controller 1304.

Additionally, the administrator may have access to a log detailing all available batteries, along with their relative health, charge state, and other relevant information. If a problem arises with a given charging/swap station 1100—such as battery overheating, insufficiently charged batteries, or similar issues—an alert may be automatically sent to the administrator. This ensures that a network of charging/swap stations can be managed efficiently and reliably.

The charging/swap station 1100 may utilize RS485 communication. The charging/swap station 1100 may interact with multiple batteries through a half-duplex, differential signaling method over a twisted pair cable. Details of an exemplar communication protocol are below.
1. Topology: RS485 typically employs a daisy-chain or multi-drop topology. In a daisy-chain, all devices are connected in series, while in a multi-drop, each device connects to a central bus line.
2. Initiation: The charging/swap station initiates communication by sending out a query or command. This may involve polling each battery device sequentially or addressing a specific battery directly.
3. Addressing: Each battery on the RS485 network is assigned a unique address. The station includes the address of the intended recipient(s) in the query packet. This helps ensure that only the targeted battery responds to the query.
4. Transmission: The station transmits the query packet onto the RS485 bus using
differential signaling. The query packet may contain information about voltage, current, temperature, state of charge, serial number, etc.
5. Listening and Response: Upon receiving the query packet, the batteries on the network monitor the bus for their address. If a battery device recognizes its address in the query, it prepares to respond accordingly.
6. Error Checking: Both the station and battery devices implement error-checking mechanisms, such as cyclic redundancy check (CRC), to ensure data integrity during transmission.
7. Acknowledgment: After receiving responses from the battery, the station acknowledges successful communication or requests re-transmission if errors are detected.

### 3. Universal Interchangeable Battery Swap Adapter for Electric Vehicles

This disclosure provides a swappable universal battery designed to power a range of electric vehicles, including e-scooters, electric bicycles, scooters, cars, cargo vans, golf carts, and others. FIGS. 1-5 and 7-8 illustrate examples of various features of the swappable universal batteries of this disclosure.

Certain vehicles may be powered by a single battery, while larger vehicles are powered by multiple batteries (e.g., using the swap system illustrated in FIGS. 14A and 14B). One or more backup or redundant batteries may be used in a vehicle to ensure power availability in cases of battery failure or depletion, as described further below.

When the battery (or batteries) in an electric vehicle are discharged or nearly depleted, they can be removed and replaced with more fully charged batteries of the same design. The swappable universal battery not only fits into a specialized universal adaptor on or within the electric vehicle (see FIGS. 14A and 14B) but is also compatible within a battery charger, such as a compartment of the charging/swap station included in the battery ecosystem.

The swappable universal battery provides a flexible and efficient solution for a diverse range of electric vehicles, which can be designed or retrofitted to utilize one or more of the swappable universal batteries.

The swappable universal battery has physical dimensions and a weight that allow most users to easily lift, carry, and position the batteries within an electric vehicle, such as in compartments of a universal battery swap adapter (illustrated in FIGS. 14A and 14B) and a charging compartment of a charging/swap station. For example, a swappable universal battery may have a height of about 375 millimeters (mm), a depth of about 100 mm, a length of about 175 mm with a weight of about 11 kg. FIG. 8 also provides labeled dimensions of an example swappable universal battery.

These examples of battery dimensions and weight are provided in this disclosure for illustrative purposes only. Other physical dimensions and weight may be utilized as long as most users, or a typical user, can lift the battery relatively easily to facilitate swapping when needed.

As described above, the BMS may include circuitry for wireless communication, such as cellular communication, Bluetooth, Wi-Fi, or similar technologies, allowing battery information and/or controls can be transmitted between the battery and an external device. For example, the battery may communicate with a mobile device, such as a smartphone, of an operator of an electric vehicle powered by the battery. The mobile device can display properties of the battery (e.g., similar to those available on the battery's display but more easily accessible when operating the vehicle).

This information enables the operator to proactively switch to a redundant battery (e.g., using an adapter as shown in the example of FIGS. 14A and 14B, described below) or plan battery swapping activities, such as locating a nearby charging/swap station and confirming a battery is available at the station.

Wireless communication may be utilized to send an alert to the operator's device when a battery swap will be needed in the future (e.g., when a certain state of charge is reached and/or based on recent driving and/or battery usage trends). Additionally, the battery can communicate with a charger (e.g., a charging/swap station) used to recharge it. For example, a battery's temperature, state of charge, and other relevant data. can be transmitted to the charging/swap station, which can then use this information to adjust charging parameters accordingly. If a battery is determined to beat too high of a temperature, the charging station might implement a slower charging schedule to help extend the battery's longevity.

This disclosure provides a universal interchangeable battery swap adapter for installation in electric vehicles, enabling them to be powered by one or more of the swappable universal batteries described above with respect to FIGS. 1-9. The battery swap adapter holds the swappable universal batteries and manages their usage to power the vehicle by facilitating communication between the batteries, their BMSs, and the vehicle's control systems. Vehicles can be manufactured with the battery swap adapter in place, or existing vehicles can be retrofitted to accommodate the battery swap adapter.

In some cases, the battery swap adapter provides the following technical features and advantages:
1. Physical Connection: The BMS of the batteries may be physically connected to the vehicle's electronic system through a wiring harness or connector. The RS485 communication lines connect the BMS to the vehicle's control unit.
2. Data Format: RS485 communication may be utilized, involving the transmission of data in a specific format that typically includes a start bit, data bits, an optional parity bit, and stop bit. The BMS and the vehicle's control unit must agree on the data format to ensure proper communication, and the battery swap adapter facilitates compatibility.
3. Data Exchange: The BMS may continuously monitor the status of the battery cells, tracking parameters such as voltage, current, temperature, and state of charge. This data is collected and formatted according to a predefined protocol.
4. Transmission Protocol: The BMS may employ a transmission protocol compatible with RS485 for communication with the vehicle's control unit. This protocol defines how data is framed, transmitted, and interpreted.
5. Integration with Vehicle Systems: The data exchanged between the BMS and the vehicle's control unit is utilized by various vehicle systems, including the propulsion system, energy management system, and safety systems. For example, the propulsion system may adjust power delivery based on battery status, while the energy management system may optimize energy usage for efficiency. The battery swap adapter ensures that this data is accessible and usable by relevant systems.

FIGS. 14A and 14B illustrate an exemplary battery swap adapter 1400. FIG. 14A shows the battery swap adapter 1400 from the front, highlighting the handles, displays, and front plugs of the batteries 100 visible (see FIGS. 1-5 and 7 for reference). FIG. 14B shows the battery swap adapter 1400 from the rear. In the example of FIGS. 14A and 14B, the battery swap adapter 1400 accommodates eight batteries 100; however, other battery swap adapters may accommodate more of fewer batteries (e.g., from one to more than eight), depending on the power requirements of the vehicle in which the battery swap adapter is installed.

The 4×2 battery configuration shown in FIGS. 14A and 14B is provided for example only. Battery swap adapters may feature different physical battery configurations to ensure that they fit within an available space of the vehicle being powered by the batteries. For example, a battery swap adapter for a kick scooter or electric bicycle may have an adapter that fits a single 36 V battery, while a seated scooter may utilize two 36V batteries operated in series. A car may have an adapter with two sets of two batteries in series and two in parallel with a total of eight batteries (e.g., as shown in the example of FIGS. 14A and 14B).

The battery swap adapter 1400 includes a housing 1402 that forms compartments 1404 for accommodating the batteries 100, which are placed in and connected to the battery swap adapter. The batteries 100 are coupled to a battery switching controller 1406 (see FIG. 14B) that communicates with the motor controller 1408 of the vehicle in which the adapter is installed, as well as the BMSs (e.g., controller 900) of the batteries 100 connected to the battery swap adapter 1400.

The battery swap adapter 1400 facilitates efficient and reliable communication between the batteries 100 (or their BMSs) and the vehicle's control systems (e.g., the motor controller 1408 and/or other vehicle systems 1412 of FIG. 14B). The bottom plugs 104 of the batteries 100 may connect to the battery switching controller 1406 (e.g., via the connector 600 of FIG. 6 or a similar connector). The top plugs 108 of the batteries 100 can be connected to other batteries 100 within the battery swap adapter 1400 and/or to other connections on the battery switching controller 1406 to achieve a desired configuration (e.g., for increased power output).

The battery switching controller 1406 includes electronic circuitry, such as one or more processors, memory, and input/output interfaces, to control operations of the battery swap adapter 1400 and communicate with the BMSs of the batteries 100 and the motor controller 1408 of the vehicle (see example of FIG. 14C and corresponding description below). The battery switching controller 1406 may also communicate with external devices.

The battery switching controller 1406 provides power to the motor controller 1408 of the vehicle, which in turn powers the vehicle's motor 1410. The battery switching controller 1406 can enhance motor control using RS485 communication, allowing for precise monitoring of battery parameters and seamless integration with the vehicle's motor control systems. The battery switching controller 1406 may use standardized data exchange. For example, the RS485 protocol may be used in a manner that facilitates consistent and reliable data transmission between the BMSs of the batteries 100 and motor controller 1408 (e.g., motor control unit(s)), improving overall system efficiency.

Additionally, the battery switching controller 1406 offers scalability and flexibility. For example, the battery swap adapter 1400, equipped with the battery switching controller 1406 using RS485 communication, can seamlessly integrate with various types of electric vehicle, enhancing fleet scalability and operational flexibility.

In some cases, the battery swap adapter 1400 allows different battery configurations to be selected to control how batteries 100 are used to power a vehicle. For example, the battery swap adapter 1400 can be configured in a redundant power configuration, where one portion of the batteries 100 (e.g., four of the eight batteries 100 in the example of FIGS. 14A and 14B) provides power to the vehicle, while another portion of the batteries 100 (e.g., the other four of the eight batteries 100 in the example of FIGS. 14A and 14B) serves as a backup when the active batteries are depleted. The battery switching controller 1406 can switch from the active batteries to the redundant batteries when the active batteries reach a sufficiently discharged state (e.g., with 5%, 10%, 15%, or 20% or less charge remaining). As another example, the battery swap adapter 1400 can be configured in a high-power configuration utilizing all batteries 100 to provide power the vehicle. This configuration allows for increased power delivery to the vehicle when needed or desired.

In some cases, an external device or a control within the vehicle may be used to switch between battery configurations. For example, an administrator overseeing operation of a fleet of vehicles using the battery swap adapter 1400 or a user operating the vehicle equipped with the battery swap adapter 1400 may set a desired battery configuration. An administrator application executed on the administrator's device can be used to input this desired configuration. Commands corresponding to this input may be sent to the battery switching controller 1406, which then adjusts how power is provided to the motor controller 1408 to achieve the desired configuration.

If there is a need to change the configuration later, this configuration change may be performed remotely via the administrator application. Additionally, a vehicle operator driving a vehicle with the battery swap adapter 1400 may have the ability to change the battery configuration. The vehicle operator can use a control within the vehicle or an operator application executed on an external device to switch between configurations (e.g., to provide power backup or increase power output).

FIG. 14C is a block diagram of exemplary hardware for a battery switching controller 1406 in communication with other system components. The battery switching controller 1406, as shown in FIG. 14C, includes a processor 1450, memory 1452, and communication interface 1456. The processor 1450 processes and/or executes code and/or other instructions (e.g., control instructions 1454). The processor 1450 may include one or more processors, which can be specialized processors configured to execute the instructions 1454 in any appropriate format.

The memory 1452 stores any data, instructions, logic, rules, and/or code necessary for executing the functions of battery switching controller 1406. The memory 1452 may store control instructions 1454, which includes any code for implementing the various functions described in this disclosure. The memory 1452 can consist of one or more disks, tape drives, or solid-state drives, and may serve as an over-flow data storage device, storing programs selected for execution as well as instructions and data read during program execution. The memory 1452 may be volatile or non-volatile and can comprise read-only memory (ROM), random-access memory (RAM), ternary content-addressable memory (TCAM), dynamic random-access memory (DRAM), and/or static random-access memory (SRAM).

The communication interface 1456 enables wired and/or wireless communication between the battery switching controller 1406 and other components, such as the batteries 100, computer-controlled components of the vehicle, and/or external user devices 1460. For example, the communication interface 1456 may facilitate data transfer between the battery switching controller 1406 and a user device 1460 (via network 1458), the motor controller 1408, vehicle systems 1412, and/or the BMSs (e.g., controller 900 of FIGS. 9A and 9B) of batteries 100 stored in the battery swap adapter 1400.

The communication interface 1456 may include one or more serial ports (e.g., USB ports) and/or parallel ports (e.g., any type of multi-pin port) to facilitate this communication. Additionally, the communication interface 1456 may include a WIFI interface, a local area network (LAN) interface, a wide area network (WAN) interface, a modem, a switch, or a router. The processor 1450 is configured to send and receive data using the communication interface 1456, which may utilize any suitable type of communication protocol.

FIG. 14D illustrates an exemplary process 1470 for operating a battery swap adapter (e.g., the adapter 1400 of FIGS. 14A and 14B). One or more steps of the process 1450 may be performed by the battery switching controller 1406. In some cases, one or more steps may be performed by the BMS (e.g., controller 900) of one or more batteries in a battery swap adapter. The process 1470 may begin at step 1472, where an operator of a vehicle is identified. For example, the battery switching controller may determine an identity of the driver of a vehicle based on an authentication process performed to begin operating the vehicle.

At step 1474, a power configuration for the vehicle is identified. For example, the battery switching controller may determine that the vehicle operator identified at step 1472 has permission to operate in an efficiency or power-redundancy mode (e.g., with only a portion of the batteries providing power, while other batteries are reserved as backup). As another example, the battery switching controller may determine that the vehicle, associated with a predefined organization or use, is configured to operate by default in a given mode (e.g., a redundancy or efficiency mode with some batteries reserved for backup or a high-power mode with all or most batteries providing power).

At step 1476, the battery switching controller determines whether the power configuration from step 1474 is being implemented. If so, the battery switching controller proceeds to step 1486 (described further below). However, if it is not being implemented, the battery switching controller proceeds to step 1478 and switches to the power configuration determined at step 1474. For example, if the vehicle was being operated in a high-power mode but an efficiency mode was indicated at step 1474, then the battery swap adjusts to the efficiency mode by isolating a subset of the batteries from the vehicle and providing power from only the remaining batteries (see, e.g., FIGS. 10A and 10B).

At step 1480, the battery switching controller determines whether a request has been received to change the power configuration. This request may be received from the vehicle operator and/or an administrator overseeing a fleet of vehicles to which the current vehicle belongs. If such a request is received, the battery switching controller proceeds to step 1482 to determine if the requested power configuration is allowed.

For example, the battery switching controller may store or have access to rules for the vehicle, the vehicle operator, and/or the vehicle fleet, indicating which power modes are allowed under various circumstances. A given operator, vehicle, or vehicle fleet may or may not be permitted to operate in a high-power mode. In some cases, these rules may be based the current charge state of the batteries in the adapter and/or expected future use of the vehicle. For instance, if the batteries are at a relatively low charge level (e.g., below a threshold level), high-power mode operation may be restricted. Conversely, if the vehicle has several anticipated operating hours ahead (e.g., exceeding a threshold level), high-power mode may also be restricted to ensure sufficient charge remains available.

If the requested configuration is allowed, the battery switching controller proceeds to step 1478 and switches to the requested configuration. Otherwise, the battery switching controller proceeds to step 1484 and rejects the requested configuration. An alert or message may be sent to the requesting party and/or the administrator indicating the rejected request.

If a request is not received at step 1480, the battery switching controller proceeds to step 1486 and determines whether a low charge or battery fault is detected. A low charge may be detected if the state of charge of the currently used batteries falls below a predefined threshold charge value (e.g., a percentage of maximum charge). A fault may be detected if the voltage, current, temperature, or other characteristic of one or more batteries in the adapter are outside a predefined range. Any other appropriate method of battery fault detection may be employed.

If such a condition is detected at step 11486, the battery switching controller proceeds to step 1488 to determine if the adapter is currently operated in a redundant power configuration (e.g., with backup battery/batteries available). If this is the case, the battery switching controller proceeds to step 1490 and switches to the backup battery/batteries. If this is not the case, the battery switching controller proceeds to step 1492 and initiates a safe shutdown procedure for the vehicle and/or alerts the vehicle operator of the need to stop operation of the vehicle in the near future.

### 4. Mobile Application for Interchangeable Battery Swap System for Electric Vehicles

### A. Battery Swapping System

The battery swapping system described herein facilitates efficient and reliable management of battery charging and swapping infrastructure, enabling the powering of electric vehicles with a swappable universal battery. In this infrastructure, certain vehicles may be powered by a single battery, while other vehicles utilize multiple batteries of the same design. When the battery or batteries in a given electric vehicle are discharged or nearly discharged, they can be easily removed and replaced with more fully charged batteries of the same design.

These batteries can be stored and charged at a charging/swap station, which features multiple charging compartments for providing charged batteries to users and recharging the discharged ones. The swappable universal battery not only fits into an adaptor on or within the electric vehicles but also fits within the charging compartments at the charging/swap station.

A network of charging/swap stations positioned at multiple locations allows for fast and efficient battery replacement within the network's area. A depleted battery can be rapidly swapped for a charged battery (e.g., in less than 30 seconds), enabling operators to resume operations with significantly less downtime than conventional electric vehicle recharging requires. Overall, the battery swapping system facilitates the flexible and efficient powering of a range of electric vehicles using swappable universal batteries stored in the network of charging/swap stations.

The battery swapping system described herein provides technical advantages and improvements over previous technology, including the following:
1. Real-Time Monitoring and Communication: The battery swapping system may utilize a WebSocket connection for real-time communication between a server and charging/swap station software. This ensures rapid, or nearly instantaneous, transmission of commands and data, allowing for swift responses to issues and efficient monitoring of the station's status.
2. Priority-Based Battery Selection: By sorting charged batteries (e.g., based on charge level and number of charge cycles), the system can limit battery wear and extend battery lifespan. This ensures even usage of batteries, reducing the risk of degradation and maximizing overall battery performance.
3. Thorough Verification Process: The station may conduct comprehensive checks of battery properties, including temperature, voltage, and authenticity verification for each stored battery. This ensures the suitability of batteries for charging and prevents potential issues such as overcharging or damage to the station.
4. Client-Friendly Error Handling: In the event of issues during a swap process, clear error messages are displayed on the client application, guiding users on necessary actions or helping them contact support for assistance. This improves user experience and reduces frustration in case of errors.
5. Automated Reporting and Alerting: A backend application (or administrator application) may provide automated reports and alerts for station administrators, facilitating efficient monitoring of station status and user activity. This can enable proactive maintenance and troubleshooting, ensuring smooth operation of the charging network.
6. GPS-Based Swap Control: In some cases, the system may limit swap execution based on the user's proximity to a station, helping to prevent fraudulent swaps and ensuring the security of the battery exchange process. This adds an extra layer of security and helps prevent misuse of the swapping system.

FIG. 15A is a diagram of an exemplar battery swapping system 1500. The system 1500 facilitates communication of information about a charging/swap station 1506 to vehicle operators (via operator application 1512) and to vehicle fleet and/or station administrators (via administrator application 1514). The system 1500 enables remote control and monitoring of the charging/swap station 1506.

The system 1500 includes a charging/swap station 1506 with a station controller 1504 (e.g., the same as or similar to controller 1304 in FIGS. 13B and 14C) executing charging/swap station software 1516, a server 1502, a backend or administrator application 1514 (e.g., executed on an administrator device 1508), and an operator application 1512 (e.g., executed on a vehicle operator's device 1510).

### B. Charging/Swap Station and Charging/Swap Station Software

The charging/swap station 1506, which is also referred to herein simply as “station 1506”, may be a multi-battery, locker-style charging/swap station with a number of individually controllable charging compartments. This station 1506 may correspond to the charging/swap station 1100 in FIGS. 11A-11E. Each charging compartment is designed to accommodate a swappable universal battery and is equipped with a plug for charging the battery.

Each charging compartment has a door that restricts access to the batteries and is controlled by the station software 1516, as described further below. The station 1506 includes a controller 1504, or other similar device, with appropriate circuitry, such as one or more processors, memory, and communication interfaces, to execute instructions implementing the station software 1516 and communicate with the server 1502.

In an example embodiment, the station 1506 utilizes software 1516 to communicate with all station environments via the Serial RS485 protocol (12.1). Through this software 1516, information about the batteries present in the station 1506 can be obtained and controlled. Other properties of the station 1506 can also be monitored or controlled. For example, the software 1516 may manage access to stored batteries (e.g., by controlling door access to compartments storing batteries), monitor the temperatures of the batteries stored in the station 1506 or the station 1506 itself, and control the lighting at the station 1506.

In an example operation, the software 1516 communicates with components of the station 1506 via the RS485 protocol, querying the status of each battery compartment individually at regular intervals (e.g., every 10 seconds). This information may be sent to the server 1502 through a secure HTTPS API (13.1). The server 1502 can process and save the information in a database, which can later be displayed by the administrator application 1514 and/or the operator application 1512, as described further below.

In the example scenario where a battery does not receive a status request within a maximum predetermined time limit (e.g., 20 seconds), the battery may enter a fault mode and stop charging. This approach provides additional protection for both the batteries and the station 1506 in the event that the software 1516 malfunctions or another issue arises.

### C. Server

The server 1502 includes appropriate circuitry, such as one or more processors, memory, and communication interfaces (see FIG. 15B), to transmit data to and from the station software 1516, the administrator application 1514, and the operator application 1512. For example, communication between the server 1502 and the station software 1516 may be made through a secure WebSocket connection (13.2) to which the application installed on the station is connected (e.g., permanently).

If the station 1506 is unable to connect to the server 1502 (e.g., because of a problem on the server 1502, an issue at the station 1506, a lack of internet connection, etc.), the station 1506 may enter a fault mode in which power supply and charging are halted for all batteries. An alert may be sent (e.g., to the administrator application 1514) to prompt investigation and resolution of the issue.

The server 1502 may send commands 1518 to the station 1506. For example, commands can be sent to open one or multiple battery compartments, restart the station 1506, start or stop charging, reset a compartment (e.g., if an error is encountered), reset the battery management system (BMS) of one or more batteries at the station 1506, start battery compartment heating at the station 1506, and perform similar actions. In this way, the server 1502 can control at least certain aspects of the station software 1516 in real-time or near real-time. Commands 1518 to the station 1506 may be transmitted through the serial protocol (12.1) to modify various parameters of the station 1506.

The server 1502 may save information received from the station software 1516, allowing the information to be displayed both in the administrator application 1514 and the operator application 1512 through communication channels (14.1) and (14.2).

FIG. 15B shows an exemplary server 1502. The server 1502 in FIG. 15B includes a processor 1530, memory 1532, and communication interface 1542. The processor 1530 processes and/or executes code and/or other instructions (e.g., control instructions 1534). The processor 1530 may include one or more processors, which may be specialized processors configured to execute the instructions 1534 in any appropriate format.

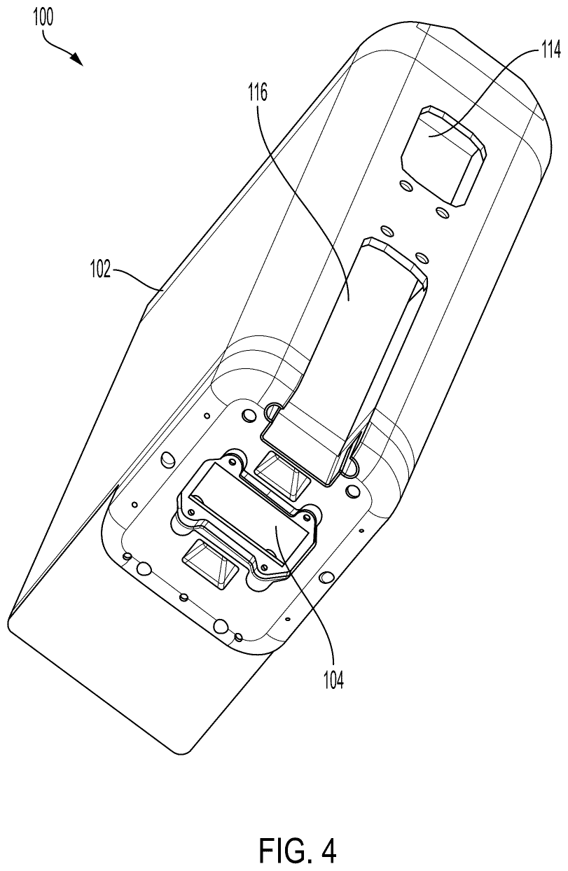

The memory 1532 stores any data, instructions, logic, rules, and/or code necessary for executing the functions of server 1502. The memory 1532 may store control instructions 1534, which include code for implementing the various functions described in this disclosure. Additionally, the memory 1532 may store permissions 1536 indicating which vehicle operators, vehicles, and/or vehicle fleets have access to the batteries stored in the charging station 1506. These permissions 1536 may indicate available power configurations for vehicles and/or operators (e.g., the redundant/efficiency mode versus the high-power mode-see FIGS. 4A-14D and corresponding description above).

The memory 1532 may also store station/battery properties 1538 (e.g., information about available batteries and their charge states) and usage logs 1540 (e.g., records of the usage of various batteries by vehicle operators). The memory 1532 includes one or more disks, tape drives, or solid-state drives, and may be used as an overflow data storage device, to store programs selected for execution, and to store instructions and data that are read during program execution. The memory 1532 may be volatile or non-volatile and may comprise read-only memory (ROM), random-access memory (RAM), ternary content-addressable memory (TCAM), dynamic random-access memory (DRAM), and/or static random-access memory (SRAM).

The communication interface 1542 enables wired and/or wireless communication between the server 1502 and other components, such as the station controller 1504, administrator device 1508, and operator device 1510. For example, the communication interface 1542 may facilitate data transmission between the server 1502 and these other system components.

The communication interface 1542 may include one or more serial ports (e.g., USB ports or the like) and/or parallel ports (e.g., any type of multi-pin port) to facilitate this communication. Additionally, the communication interface 1542 may include a WIFI interface, a local area network (LAN) interface, a wide area network (WAN) interface, a modem, a switch, or a router. The processor 1530 is configured to send and receive data using the communication interface 1542, which may be configured to use any suitable type of communication protocol.

### D. Administrator Application

Returning to FIG. 15A, the administrator application 1514 may be a web or mobile application used to view and control information about the station 1506 and other stations in the charging network. The administrator application 1514 allows an administrator to access to near real-time information about the station 1506, including its connectivity status and any issues it may be experiencing.

The administrator application 1514 can be executed by a processor of an administrator's computing device (e.g., a computer, smartphone, tablet, or similar) that stores instructions for executing the administrator application 1514 in its memory (see FIG. 15C). Additionally, the administrator application 1514 may be used to view, create, or edit vehicle fleets and the users who have access to the stations associated with these vehicle fleets.

The administrator application 1514 provides information about the station 1506 and allows maintenance commands 1520 to be sent to the station 1506. For example, the information available through the administrator application 1514 may include:
Battery Information: Details about the batteries present in the station 1506, such as number of batteries, charging status, voltage, temperatures, voltage of each cell, battery serial number, total battery capacity, and number of charge cycles. This information can be used to monitor battery performance and availability, enabling quick and efficient resolution of any detected issues.
Charging Compartment Information: Details about the charging compartments, including open/closed status, interior temperature, presence of a battery, and connection status of each battery.
Station Information: Data regarding the station itself, such as internal temperature, voltage, consumed power, instantaneous power consumption, and current level.

The administrator application 1514 can be used to manage users (e.g., vehicle operators) by adding, deleting, or editing user entries in a database that controls user access to the station 1506. Users may be organized into fleets for easier identification and for generating more detailed reports. Additionally, a maximum number of battery swaps per designated period of time (e.g., per day) can be set for each user.

The administrator application 1514 allows for remote control of the station 1506. For example, it can send commands 1520 via the server 1502 to start loading on a charging compartment, open a charging compartment, reset errors, restart the station 1506 or station software 1516, take the station 1506 offline, and/or restrict access to a charging compartment (e.g., if the compartment is malfunctioning or temporarily unavailable).

The administrator application 1514 may also provide reporting features. For example, it can be used to access logs related to the station 1506 and battery swaps performed at the station 1506. This provides a record of battery swaps performed at each station, which can be used to improve station operations. For instance, if an error occurs during a specific swap, it can trigger an alert, allowing an administrator to assist the user promptly and efficiently.

Additionally, periodic reports may be automatically generated and sent out (e.g., monthly). These reports may be grouped by station, user, fleet, etc., facilitating efficient monitoring of user activity and helping to identify the need for additional batteries and stations in specific areas. Reports can be customized and provided in a desired format from the administrator application 1514 based on selected criteria (e.g., date, user, station). The information collected by the administrator application 1514 may be utilized to perform predictive maintenance on the station 1506 and/or batteries housed within it.

Examples of alerts that may be presented on the administrator application 1514 include:
An alert that the station 1506 is offline due to various reasons, such as a power outage or internet connectivity issues.
An alert notifying that battery is missing from a station 1506, which is useful for detecting real-time theft attempts or potential battery issues.
An alert indicating that a battery cannot be charged due to being excessively discharged or having other problems.
An alert notifying that a user has performed more swaps than allowed (e.g., based on their vehicle type and the user's settings).

FIG. 15C shows an exemplary administrator device 1508. The administrator device 1508 of FIG. 15C includes a processor 1550, memory 1552, and communication interface 1562. The processor 1550 processes and/or executes code and/or other instructions (e.g., control instructions 1554). The processor 1550 may include one or more processors, which may be specialized processors configured to execute the instructions 1554 in any appropriate format.

The memory 1552 stores data, instructions, logic, rules, and/or code for executing the functions of administrator device 1508. The memory 1552 may store control instructions 1554, which includes any code for implementing the various functions described in this disclosure. Additionally, the memory 1552 may store updated permissions 1556 that indicate desired changes to the permissions 1536 stored on server 1502.

The memory 1552 may also store an alert 1558 (e.g., indicating an issue at a charging station, such as a power outage or a battery fault, or issues with a deployed vehicle or battery). The memory 1552 may store usage/battery property reports 1560 (e.g., reports generated using information from the station/battery properties 1538 and/or usage logs 1540 from server 1502).

The memory 1552 includes one or more disks, tape drives, or solid-state drives, and may be function as an overflow data storage device, storing programs selected for execution as well as instructions and data read during program execution. The memory 1552 may be volatile or non-volatile and can comprise read-only memory (ROM), random-access memory (RAM), ternary content-addressable memory (TCAM), dynamic random-access memory (DRAM), and/or static random-access memory (SRAM).

The communication interface 1562 enables wired and/or wireless communication between the administrator device 1508 and other components, such as the server 1502. The communication interface 1562 may include one or more serial ports (e.g., USB ports or the like) and/or parallel ports (e.g., any type of multi-pin port) to facilitate communication. Additionally, the communication interface 1562 may include a WIFI interface, a local area network (LAN) interface, a wide area network (WAN) interface, a modem, a switch, or a router. The processor 1550 is configured to send and receive data using the communication interface 1562, which may be configured to use any suitable type of communication protocol.

### E. Operator Application

Returning to FIG. 15A, the operator application 1512 may be a mobile application used to view available battery stations (e.g., as a list or on a map), view information about the stations and/or batteries available at the stations, and obtain a route to a selected station. For example, a vehicle operator (e.g., someone driving an electric vehicle powered by a swappable universal battery) can use the operator application 1512 to check how many charged batteries are available at the swap stations, whether the swap stations are functioning, and other relevant details. This information can assist the vehicle operator in selecting a swap station that has the appropriate number of batteries needed.

The operator application 1512 may be executed by a processor of a vehicle operator's computing device 1510 (e.g., typically a smartphone, tablet, or similar device) that stores, in memory, instructions for executing the operator application 1512 (see FIG. 15D). FIG. 16 shows an example list 1600 of available swap stations displayed by an exemplar operator application 1512.

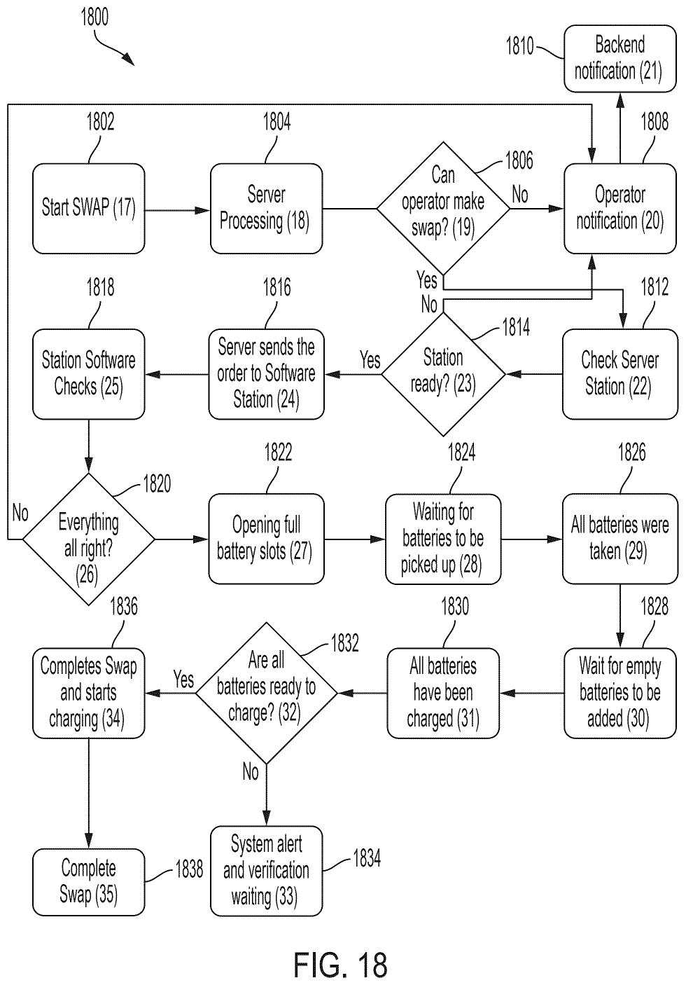

Referring to the example in FIG. 15A, the operator application 1512 may communicate with the server 1502 through a secure API (14.2) to receive information about stations 1506 and the batteries available at these stations 1506. This communication channel may also be used to send a command or request 1522 to initiate a battery swapping process, which is relayed through the server 1502 to the station software 1516, as described in greater detail with respect to FIG. 18 below.

The operator application 1512 may provide reporting that allows the vehicle operator to view information about battery swaps that have been performed. This information may be presented as graphical representations of battery swaps by day. The operator application 1512 may also display an how many battery swaps a vehicle operator has available for the current day (e.g., in cases where a daily limit is set). This reporting can help vehicle operators plan their routes effectively based on the remaining number of battery swaps for the day.

In some cases, location information from the operator application 1512 is used to control battery swaps and prevent users from engaging in fraudulent swaps. In such cases, the station software 1516 limits swaps based on the vehicle operator's distance from the station 1506. Specifically, a vehicle operator can only perform a swap if they are within a predefined distance (e.g., 50 meters) of the station 1506. This may be achieved by comparing the GPS location of the vehicle operator's device to the known location of the station 1506.

FIG. 15D shows an exemplary operator device 1510. The operator device 1510 includes a processor 1570, memory 1572, and communication interface 1584. The processor 1570 processes and/or executes code and/or other instructions (e.g., control instructions 1574). The processor 1570 may include one or more processors, which may be specialized processors configured to execute the instructions 1574 in any appropriate format.

The memory 1572 stores data, instructions, logic, rules, and/or code necessary for executing the functions of operator device 1510. The memory 1572 may store control instructions 1574, which include the code for implementing various functions described in this disclosure. Additionally, the memory 1572 may maintain a record of available stations and/or batteries 1576 (e.g., as illustrated in the list in FIG. 16). The memory 1572 may store a usage report 1578 indicating, for example, usage of batteries, vehicle(s), and/or swap station(s) by the user of the operator device 1510.

The memory 1572 may store an alert 1580 (e.g., indicating that a battery swap is needed or another issue requires attention). The memory 1572 may also store a current location of the operator device 1510 (e.g., to facilitate access to a battery in the charging station 1506, as described above. The memory 1572 includes one or more disks, tape drives, or solid-state drives, and may function as an overflow data storage device, storing programs selected for execution, as well as instructions and data read during program execution. The memory 1572 may be volatile or non-volatile and can comprise read-only memory (ROM), random-access memory (RAM), ternary content-addressable memory (TCAM), dynamic random-access memory (DRAM), and/or static random-access memory (SRAM).

The communication interface 1584 enables wired and/or wireless communication between the operator device 1510 and other components, such as the server 1502. The communication interface 1584 may include one or more serial ports (e.g., USB ports) and/or parallel ports (e.g., any type of multi-pin port) to facilitate this communication. Additionally, the communication interface 1584 may include a WIFI interface, a local area network (LAN) interface, a wide area network (WAN) interface, a modem, a switch, or a router. The processor 1570 is configured to send and receive data using the communication interface 1584, which may be configured to use any suitable type of communication protocol.

### Example Process for Using the Battery Swapping System

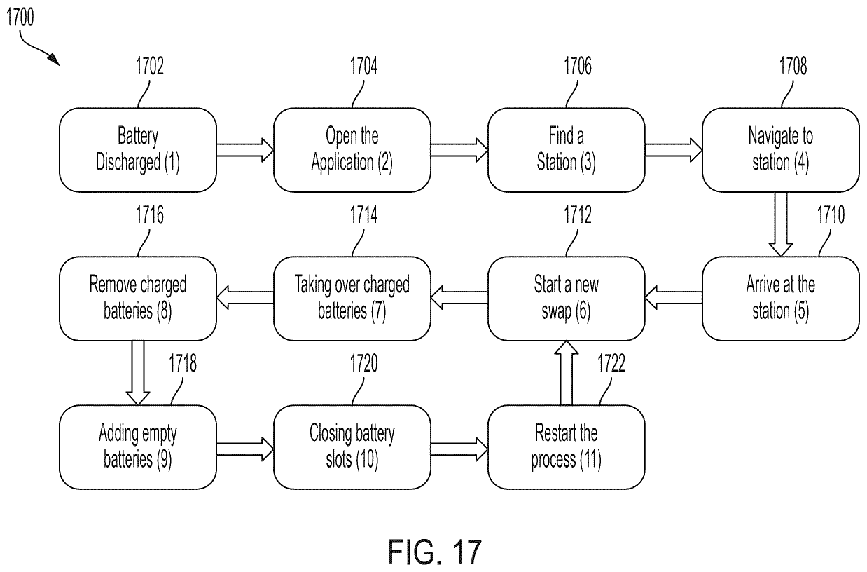

FIG. 17 illustrates an exemplar process 1700 performed by a vehicle operator to swap a depleted battery for a charged battery at a swap station. The process 1700 may begin at step 1702, where a vehicle operator determines that their vehicle's battery has a low charge and needs to be changed (e.g., by monitoring battery charge in the operator application 1512 or receiving an alert from the operator application 1512). In this condition, the vehicle will have a limited range.

At step 1704, the vehicle operator accesses the operator application 1512. At step 1706, the vehicle operator uses the operator application 1512 to locate and select a swap station that has batteries suitable for the operator's type of vehicle (see example list of stations shown in FIG. 16). A map to the station may be displayed on the operator's device; for instance, the operator application 1512 may open a navigation application that to assist in reaching the selected station. At step 1708, the vehicle operator travels to the selected station.

Upon arrival at the station at step 1710, the vehicle operator uses the operator application 1512 to initiate the battery swap process at step 1712, for example, by pressing a button in the operator application 1512 that starts the exchange. The station 1506 or server 1502 may then verify the account type and the number of batteries needed by the vehicle operator. Additional checks may also be performed (e.g., device location, user permissions, etc.), as described above with respect to FIG. 15A and below with respect to FIG. 18.

At step 1714, the station 1506 rants access to charging compartments containing charged batteries based on the vehicle type. At step 1716, the vehicle operator disconnects the charged battery and removes it from its compartment. At step 1718, the vehicle operator inserts the discharged battery into the now-empty compartment and plugs in the discharged battery to begin recharging. At step 1720, the battery compartment is closed.

After this portion of process 1700, the station 1506 performs checks to confirm that all batteries are ready for charging and everything is functioning properly. Upon completing these checks, the station begins charging the discharged battery. At step 1722, the battery swap process 1700 can be restarted or concluded.

### Example Process for Operating the Battery Swapping System

FIG. 18 illustrates an exemplary process 1800 for operating the battery swapping system shown in FIG. 15A. This swapping process 1800 illustrates how components of the battery swapping system function during a battery swap. The swapping process may begin at step 1802, where a swapping action is initiated from the operator application 1512.

At step 1804, the server 1502 processes the request by performing checks to verify that the vehicle operator is eligible to perform the requested battery swap. At step 1806, the server 1502 determines whether the operator has permission to proceed with the battery swap. For example, the server 1502 may determine whether the operator is active (e.g., has permission to swap a battery, has remaining swap(s) available for that day, is part of an active fleet, etc.).

If the swap is not allowed, a notification is sent to the vehicle operator at step 1808. Notifications may include: “Your account is inactive, and you cannot perform a swap! Please contact support to verify the status of your account!”; “Your fleet membership is suspended in our platform! Please get in touch with your fleet manager!”; or “The maximum number of charges has been reached!”

At step 1810, a notification may also be sent to the administrator application 1514, ensuring that an administrator is aware of the vehicle operator's failure to complete a desired battery swap.

If the verification process at step 1806 is successful, the process 1800 proceeds to step 1812, where additional checks are performed for the selected station 1506. At step 1814, the server 1502 determines whether the selected station 1506 is ready. For example, the server 1502 may determine/confirm one or more of the following:
The station 1506 is online.
The station 1506 has charged batteries available for the vehicle type.
The station 1506 has no communication or internal errors.

If the station 1506 is not ready at step 1814, an error message is displayed in the client application at step 1808, and the swap is not permitted. If the station 1506 is ready at step 1814, a command is sent (e.g., using WebSocket as described above with respect to FIG. 15A) from the server 1502 to the selected station 1506 at step 1816. The command typically includes a request to initiate the requested battery swap.

At step 1818, the station 1506 receives the command from the server 1502 and begins performing checks to ensure that the station 1506 is ready and capable of carrying out the battery swap. For example, at step 1820, the station 1506 may verify whether the required number of charged batteries needed by the vehicle operator are available. If multiple batteries of this type are charged, they may be sorted by charge level and by the number of charge cycles the batteries have undergone, with priority given to batteries that have experienced the fewest charge cycles. This process helps equalize battery wear, preventing significant degradation in some batteries while others remain largely unaffected.

Once the station 1506 (e.g., using the station software 1516) has completed all necessary checks at step 1820, if something is not right, the process 1800 proceeds to step 1808, sending a notification to the vehicle operator. This notification indicates that the swap cannot be completed and may be sent to the operator's device via the operator application 1512 and/or displayed on an electronic display at the station 1506. An example of a notification sent/displayed in this scenario is “We apologize, but an error has occurred, and the swap cannot be completed! Please try again or contact support!”

If all checks pass at step 1820 and the station software 1516 has determined that there are a sufficient number of available batteries, a battery to be provided to the vehicle operator is selected (e.g., based on the prioritization of charge level and cycle number described above). At step 1822, the station software 1516 sends a command to open the charging compartments holding the selected batteries. The command may be transmitted through the Serial RS485 communication channel, as described above. The charging compartments containing the charged batteries are then unlocked or opened. The station software 1516 waits for the charged batteries to be collected at step 1824. Collection of the batteries includes disconnecting the charged batteries and removing them from their charging compartments in the station 1506.

After all requested and approved batteries have been disconnected and taken by the vehicle operator, the station software 1516 may confirm that all batteries were removed at step 1826. The station software 1516 then verifies that the discharged batteries are placed in the newly empty charging compartments at step 1828. The vehicle operator inserts each discharged battery into an open charging compartment and connects the batteries for charging. The vehicle operator then closes the doors of the charging compartments to secure the batteries. At step 1830, the station software 1516 determines that all of the recently opened charging compartments have correctly received the discharged batteries for charging. At step 1832, a verification process is performed to determine whether all batteries are ready to charge. For example, the station software 1516 may perform one or more of the following:
Temperature check.
Voltage check (e.g., to determine if the battery has too low a voltage, in which case the station 1506 may not start charging due to the risk of a defect with that battery).
Battery authenticity check (e.g., verification that the inserted battery has a serial number in the database to prevent receiving batteries with a different number or a counterfeit battery).
Voltage check for each cell of the battery individually (e.g., if a cell is defective, charging is prevented to avoid further degradation of the battery or potential technical issues at the station).

If at least one battery has an issue at step 1832, the process 1800 proceeds to step 1834, where an error message is displayed (e.g., on the station's display). For example, the message may read “A problem has been encountered with the battery inserted in compartment X. Please contact support team for further assistance.” Additionally, a notification may be sent to an administrator's device via the administrator application 1514. This notification may detail the issue at the station 1506, indicating, for example, “At station Y, in compartment X, a battery has been inserted that cannot be charged due to too low voltage. The user who inserted this battery is Z. Please check the battery and contact the user.”

If all verifications are completed at step 1832, the process proceeds to steps 1836 and 1838 where the swap is considered completed and the station 1506 begins charging the battery. The following message may appear on the station's display: “The Swap process has been successfully completed! Returning to the main page in 30 seconds.” At this point, the station 1506 has completed the swap and is ready for another battery swap. If the vehicle operator wishes to perform another battery swap, they can reopen the operator application 1512 and restart the procedure from the beginning. Throughout process 1800, the station 1506 may continuously communicate with the server 1502, sending real-time data about ongoing actions, including information about both the in-progress battery swap and the batteries already in the station. This information may be transmitted through both the secure HTTPS API communication channel and the continuously open WebSocket (see FIG. 15A).

While this disclosure primarily focuses on providing a universal and interchangeable battery system for electric vehicles, several alternative embodiments and potential variations are contemplated by this disclosure, as described in the following examples:
1. Marine and Aerospace Applications: The concepts underlying this technology, such as seamless load transfer, fault recovery, and redundancy, can be adapted to marine vessels and aerospace systems. By modifying the system to withstand harsh environmental conditions and meet specific safety standards, the technology of this disclosure can enhance the performance and reliability of marine propulsion systems, electric aircraft, and spacecraft.
2. Stationary Power Systems: The advanced control logic and fault handling capabilities described in this disclosure can be applied to stationary power systems, such as backup generators, renewable energy storage systems, and microgrids. Integrating the approach described in this disclosure with these applications may lead to improved reliability, efficiency, and energy management, particularly in critical infrastructure and remote locations.
3. Industrial and Commercial Equipment: The principles of battery management, fault tolerance, and power distribution described herein can be applied to a wide range of industrial and commercial equipment that relies on battery power. Examples include forklifts, warehouse vehicles, construction machinery, and mobile power generators. By incorporating the batteries and/or processes described herein, these applications may achieve greater operational uptime, efficiency, and safety.
4. Customization for Specific Vehicle Types: The technology described in this disclosure can be customized and optimized for specific types of vehicles, such as buses, trucks, motorcycles, and recreational vehicles. Customizing the system's parameters, control algorithms, and component selection to meet the unique requirements of each vehicle type may maximize its effectiveness and usability across diverse transportation scenarios.
5. Integration with Renewable Energy Sources: The disclosed technology could be integrated with renewable energy sources, such as solar panels or wind turbines, to provide sustainable charging solutions for electric vehicles, thereby reducing reliance on grid electricity.
6. Fleet Management Software Integration: The disclosed technology may be integrated with fleet management software to improve battery usage, monitor performance, and schedule maintenance efficiently, enhancing overall fleet operations.
7. Vehicle-to-Grid (V2G) Capability: The disclosed technology may incorporate vehicle-to-grid (V2G) technology, allowing electric vehicles equipped with the battery swap adapter to provide grid stabilization services by feeding surplus energy back into the electrical grid during peak demand periods

Other example variations contemplated by this disclosure are described below.
1. Different Charging/Swap Station Configurations: While the described system primarily focuses on battery swapping for electric vehicles, variations could involve adapting the system for different types of charging/swap stations, such as those utilizing fast-charging technology or wireless charging.
2. Integration with Renewable Energy Sources: To promote sustainability, alternative embodiments might integrate charging/swap stations with renewable energy sources, such as solar panel arrays or wind turbines, to reduce reliance on the grid and minimize environmental impact.
3. Multi-Use Battery Swapping Stations: Instead of focusing on electric vehicles, the system could be modified to support battery swapping for other applications, such as portable electronic devices, thereby expanding its utility and market potential.
4. Modular Station Designs: Alternative embodiments could explore modular station designs that allow for scalability and customization based on varying user needs and geographical locations. Such designs could also facilitate easier deployment and maintenance of charging infrastructure.
5. Smart Grid Integration: Alternative embodiments of the system could incorporate smart grid technology to optimize energy usage, manage peak demand, and enable bidirectional power flow between the grid and electric vehicles, thereby enhancing grid stability and efficiency.
6. Enhanced User Experience Features: Alternative embodiments of the system could include additional features to improve the user experience, such as integration with voice assistants, mobile payment options, reservation systems for battery swaps, or loyalty programs for frequent users.
7. Emergency Power Backup: Alternative embodiments of the system could incorporate emergency power backup capabilities into the charging/swap stations to ensure continued operation during power outages or emergencies, thereby providing a reliable source of energy for electric vehicles in critical situations.
8. Adaptive Battery Management Algorithms: Alternative embodiments of the system could incorporate advanced algorithms to optimize battery swapping operations based on factors such as battery health, usage patterns, and environmental conditions, thereby prolonging battery lifespan and improving overall system efficiency.

### Non-Limiting Definitions

The terms “a”, “an” and “the” are intended to include the plural forms as well, unless the context clearly indicates otherwise.

The terms “comprises” and/or “comprising”, when used in this specification, specify the presence of stated features, steps, operations, elements, and/or components, but do not preclude the presence or addition of one or more other features, integers, steps, operations, elements, components, and/or groups thereof.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any portions of this application. Where the context permits, words in the above Detailed Description using the singular or plural number may also include the plural or singular number, respectively. The word “or,” in reference to a list of two or more items, covers all the following interpretations of the word: any of the items in the list, all the items in the list, and any combination of the items in the list.

Several implementations of the disclosed technology are described above in reference to the figures. The computing devices on which the described technology may be implemented can include one or more central processing units, memory, input devices, output devices (e.g., display devices), storage devices, and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes are presented in a given order, alternative implementations may perform routines having steps in a different order, and some processes may be deleted, moved, added, subdivided, combined, and/or modified to provide alternative or sub-combinations. Each of these processes may be implemented in a variety of different ways. Also, while processes are at times shown as being performed in series, these processes or blocks may instead be performed or implemented in parallel or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system comprising:
a battery swap adapter configured to communicate with a motor controller of an electric vehicle in which the battery swap adapter is installed, the battery swap adapter comprising at least a first compartment and a second compartment, the first compartment configured to house a first swappable universal battery and the second compartment configured to house a second swappable universal battery;
the first swappable universal battery and the second swappable universal battery, each sized and shaped to be moved between the first compartment and the second compartment, respectively, of the battery swap adapter and a charger, the first swappable universal battery comprising:
a housing storing at least one battery cell, the housing configured to be removably secured in the first compartment of the battery swap adapter of the electric vehicle and in a charging port of the charger;
a first plug located on a first surface of the housing, the first plug configured to allow charging of the at least one battery cell when the swappable universal battery is in the charger and to allow powering of the electric vehicle by the at least one battery cell when the swappable universal battery is in the compartment of the battery swap adapter of the electric vehicle, wherein the first plug is configured to couple to a corresponding connector in the first compartment; and
at least one second plug located on a second surface of the housing opposite the first surface, the at least one second plug configured to power the electric vehicle in combination with the second swappable universal battery held in the second compartment of the battery swap adapter such that first and second swappable universal batteries are physically separated.

2. The system of claim 1, wherein the housing comprises:
an alignment slot configured to:
align the housing within the first compartment of the battery swap adapter of the electric vehicle when the first swappable universal battery is used to power the electric vehicle, and
align the housing with the charging port of the charger when the first swappable universal battery is charged.

3. The system of claim 1, wherein the housing comprises:
a locking mechanism configured to:
secure the housing within the first compartment of the battery swap adapter of the electric vehicle when the first swappable universal battery is used to power the electric vehicle, and
secure the housing within the charging port of the charger when the first swappable universal battery is charged.

4. The system of claim 1, wherein the first swappable universal battery further comprises a handle attached to the housing, the handle facilitating movement of the swappable universal battery between the electric vehicle and the charger by an operator of the electric vehicle.

5. The system of claim 1, further comprising a display coupled to the housing, the display configured to show properties of the first swappable universal battery, the properties comprising at least one of a battery state of charge, a battery voltage, a battery current, a battery temperature, a wireless connection status, and an error status.

6. The system of claim 1, wherein the first swappable universal battery can be used to power a second electric vehicle of a different type than the electric vehicle.

7. The system of claim 1, wherein the first swappable universal battery further comprises isolation circuitry configured, when a relay of the isolation circuitry is opened, to electronically isolate the first swappable universal battery from power systems of the electric vehicle.

8. The system of claim 1, wherein the first swappable universal battery further comprises a controller configured to, when the first swappable universal battery is providing power to the electric vehicle:
detect a battery fault or low state of charge of the first swappable universal battery;
isolate the first swappable universal battery from the electric vehicle; and
allow the second swappable universal battery to power the electric vehicle.

9-20. (canceled)

21. The system of claim 1, wherein, when the first swappable universal battery is secured in the first compartment of the battery swap adapter:
the first plug is configured to couple to the corresponding connector positioned at an internal surface of the first compartment; and
the at least one second plug is configured to be accessible via an opening of the first compartment through which the first swappable universal battery can be moved.

22. The system of claim 1, wherein, when the first swappable universal battery is secured in the charger:
the first plug is configured to couple to a corresponding connector positioned at an internal surface of a charging port compartment of the charger; and
the at least one second plug is configured to be accessible via an opening of the charging port compartment through which the first swappable universal battery can be moved.

23. The system of claim 1, wherein the first swappable universal battery further comprises a controller configured to communicate properties of the first swappable universal battery for display on a mobile device, the properties comprising at least one of a battery state of charge, a battery voltage, a battery current, a battery temperature, a wireless connection status, and an error status.

24. The system of claim 7, wherein the isolation circuitry comprises a solid-state switch configured to electronically isolate the first swappable universal battery from power systems of the electric vehicle when a temperature of the first swappable universal battery is greater than a threshold value.

25. The system of claim 1, wherein the connector in the first compartment comprises a plurality of prongs configured to transmit power between the at least one battery cell and the electric vehicle.

26. The system of claim 1, wherein the battery swap adapter further comprises a battery switching controller configured to automatically switch between providing power to the motor controller from (i) the first swappable universal battery, (ii) the second swappable universal battery, and (iii) both the first swappable universal battery and the second swappable universal battery.
